(19) United States
(12) Patent Application Publication
(10) Pub. No.: US 2026/0228593 A1
(43) Pub. Date: Aug. 6, 2026

(54) MODULAR DECODING

(71) Applicant: PsiQuantum, Corp., Palo Alto, CA (US)

(72) Inventors: Yehua Liu, Mountain View, CA (US); Fernando Martin Pastawski, Berlin (DE); Sam Roberts, Renwick (AU)

(21) Appl. No.: 19/153,915

(22) PCT Filed: Feb. 5, 2024
(86) PCT No.: PCT/US2024/014510

§ 371 Date: Aug. 5, 2025

Related U.S. Application Data
(60) Provisional application No. 63/443,697, filed on Feb. 6, 2023.

(51) Int. Cl. G06N 10/60; G06F 9/30

(52) U.S. Cl. CPC G06N 10/60; G06F 9/3016

(57) ABSTRACT

Quantum information processing systems can implement error correction decoding to extract logical outcome data from readout data. A modular decoder system can perform modular decoding of sub-tasks on different decoders with low communication between the decoder units and without sacrificing decoding accuracy. The modular decoder system can implement decomposition of a global decoding problem into sub-tasks comprising commit regions and buffers for efficient and accurate decoding of quantum data.

### CROSS-APPLICATION REFERENCE

This application claims priority to and the benefit of U.S. Provisional Patent Application No. 63/443,697, filed on Feb. 6, 2023, the contents of which are incorporated herein by reference in its entirety.

### TECHNICAL FIELD

The present disclosure generally relates to data processing, and more particularly, to decoding outcome data.

### BACKGROUND

Quantum computing systems implement qubits for information processing tasks. Whereas bits in conventional non-quantum computing systems (e.g., electronic computing systems, microprocessors) can represent a first state (e.g., binary “1”, a high state) or a second state (e.g., binary “0”, a low state), qubits of quantum computing system can represent a first state and a second state, but also a superposition of the first and second state where the qubits can have complex-valued representations that can be entangled with one another in a complex space (e.g., Hilbert space). Measurements of quantum state can be implemented via measurement devices to form readout data, which may undergo data processing to form outcome data.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, or characteristic included in at least one implementation of the inventive subject matter. Thus, phrases such as “in one embodiment” or “in an alternate embodiment” appearing herein describe various embodiments and implementations of the inventive subject matter, and do not necessarily all refer to the same embodiment. However, they are also not necessarily mutually exclusive. To easily identify the discussion of any element or act, the most significant digit or digits in a reference number refer to the figure (“FIG.”) number in which that element or act is first introduced.

FIGS. 1A-1J show examples of qubits and logical representations, in accordance with some example embodiments.

FIG. 2 shows an example a quantum information processing system, in accordance with some example embodiments.

FIG. 3 shows example decoding architecture, in accordance with some example embodiments.

FIGS. 4A-4C show example decoding approaches, in accordance with some example embodiments.

FIG. 5 shows an architecture for processing user instructions with quantum logical objects, in accordance with some example embodiments.

FIG. 6 shows a data flow architecture for processing user instructions and modular decoder data, in accordance with some embodiments.

FIGS. 7A and 7B show details of logical block gates, in accordance with some embodiments.

FIG. 8 shows a data flow architecture for processing decoder data, in accordance with some embodiments.

FIG. 9 shows partitioning data for decoding, in accordance with some embodiments.

FIG. 10 shows an additional example of partitioning data for decoding, in accordance with some example embodiments.

FIG. 11 shows graphs and scheduling, in accordance with some example embodiments.

FIGS. 12A and 12B show example runtime processing for modular decoding in which the decoder units use data from other decoder units, in accordance with some example embodiments.

FIG. 13A-13E show modular decoding for magic stage injection, in accordance with some example embodiments.

FIGS. 14A and 14B show modular decoding for magic state distillation, in accordance with some example embodiments.

FIG. 15 shows a flow diagram of a method for implementing modular decoding, in accordance with some embodiments.

Descriptions of certain details and implementations follow, including a description of the figures, which may depict some or all the embodiments described below, as well as discussing other potential embodiments or implementations of the inventive concepts presented herein. An overview of embodiments of the disclosure is provided below, followed by a more detailed description with reference to the drawings.

### DETAILED DESCRIPTION

In the following description, for the purposes of explanation, numerous specific details are set forth to provide an understanding of various embodiments of the present disclosure. It will be evident, however, to those skilled in the art, that embodiments of the inventive subject matter may be practiced without these specific details. In general, well-known instruction instances, structures, and techniques are not necessarily shown in detail.

A quantum information processing system (e.g., quantum computer) can implement qubits to perform steps of a quantum instruction set, such as a quantum algorithm, quantum circuit, a list of qubit operations, and the like. The qubits can be physical qubits that can undergo errors (e.g., phase error, flips, erasure), due to unwanted interactions between the qubit and its environment, or faulty components. Error correction techniques can be implemented to address the errors that occur on the qubits during operation, by identifying them and correcting them. In some example embodiments, a collection of physical qubits can function in concert as a logical qubit (e.g., such as a logical qubit in a quantum error-correcting code like the surface code). In some approaches, quantum decoding schemes—such as Union Find, minimum weight perfect matching (MWPM), etc.—can process physical qubit readout data (e.g., physical outcome data, measurement data) to determine logical outcome data for the logical qubits.

Generally, a decoder can be implemented to generate error-corrected logical outcome data of a fault-tolerant protocol (e.g., that corresponds to one or more logical qubits). The amount of data that is generated from measurement of physical qubits can become so large (e.g., gigabits per second per logical qubit) that it can be difficult to implement the decoding schemes in a real time practical manner (e.g., to determine what the next logical operations are to be issued according the runtime quantum algorithm) with available computational and physical resources, such as processors (e.g., central processing units, classical processors), memory, data routing, electrical power, and cooling power.

In some example embodiments, a modular decoder system can be implemented that organizes a global decoding task for a particular quantum instruction set into concurrently processable sub-decoding tasks handled by multiple modular decoder units. The modular decoding units can be implemented by classical processors (e.g., hardware or virtualized processors, CPUs, GPUs, nodes). In some example embodiments, the qubit measurement data is partitioned into different commit regions, where each modular decoder unit applies the same designated decoding scheme (e.g., Union Find, minimum weight perfect matching) to its received data to generate portions of decoded data.

While parallel processing tasks can lead to an increase in processing throughput, separating the readout data and decoding in parallel does not ensure that decoded output data is valid. For example, partitioning outcome data for parallel processing, without communication, can actually decrease the fault tolerance of the protocol, as the corrections determined by parallel decoders may be incompatible and a logical error may be introduced in the process. To address the foregoing, in some example embodiments, per a given error tolerance value (e.g., fault distance, d; a minimum number of errors to flip a logical measurement) of a given code, the global decoding task (e.g., global data for decoding) is partitioned in such a way that ensures that the data can be partitioned and decoded in parallel, thereby enabling scalable decoding that can handle high readout throughputs of modern qubit processing systems.

In some example embodiments, the data for decoding is partitioned into a first set of commit regions (e.g., edge tasks) having buffers and a second set of commit regions (e.g., vertex tasks) that do not have buffers, where buffers are additional adjacent data for decoding as further discussed below. The second set of commit regions can be adjacent to the first set of commit regions (e.g., the second set of commit regions overlap onto the buffers of the first commit region). In some example embodiments, the buffer size is set to the selected distance of the code, d; while in some other example embodiments, the buffers are set such that they are least (d−1)/2 in size to ensure decoding soundness in the modular approach. In other embodiments, the buffer is a variable and tunable parameter that can be determined so as to achieve the desired accuracy and speed of the decoding protocol.

In some example embodiments, the modular decoding units load the first set of commit regions with buffers and applies the decoding scheme to the commit regions and the buffers. In some embodiments, the buffers enable the decoding of the first commit regions to be more accurate; however, the actual commit data for the first commit regions is only that data that extends from the first commit region to the boundary between the first commit region and the buffer. That is, the correction data is generated for the first commit region and its corresponding buffers, but only the first commit region correction data is implemented for corrections (e.g., later evaluation in global processing).

In some example embodiments, after the decoding of the first commit region, the first commit region decoded data (e.g., updated boundary data, syndrome data extended to the boundary between the first commit region and the buffer, as further discussed below) is loaded into other decoder units for use in decoding the second set of commit regions. In some embodiments, the other decoders apply the decoding scheme based on the identified syndrome data in the second commit regions along with the updated boundary data to generate second correction data. In some example embodiments after the first and second commit regions are decoded, additional global processing consolidates the decoded data to determine logical outcome data (e.g., logical qubit outcomes).

In some example embodiments, the list of steps to be processed (e.g., by a qubits) are arranged as sets of logical gate data (e.g., space-time protocols, logical block networks, quantum instrument networks, ZX diagrams, and the like). In some example embodiments, the logical gate data is partitioned into edge regions and vertex regions where only the edge regions have buffers, and no edge commit regions are adjacent to one another. The edge and vertex data can be organized into a scheduling graph (e.g., directed acyclic graph) which can be used to perform scheduling at runtime.

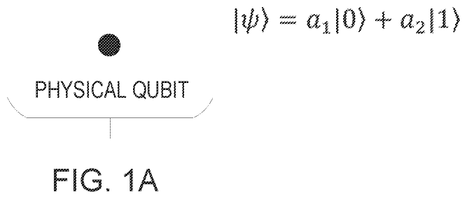

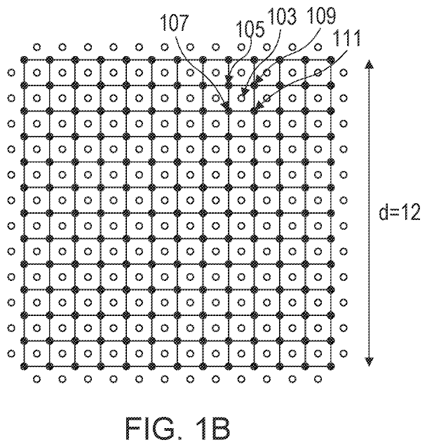

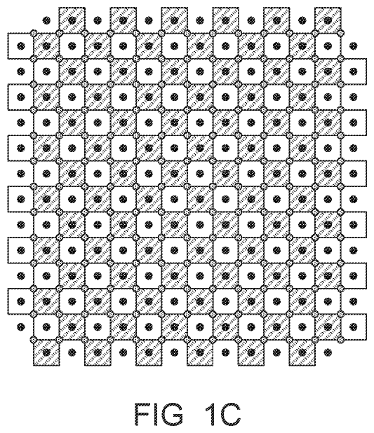

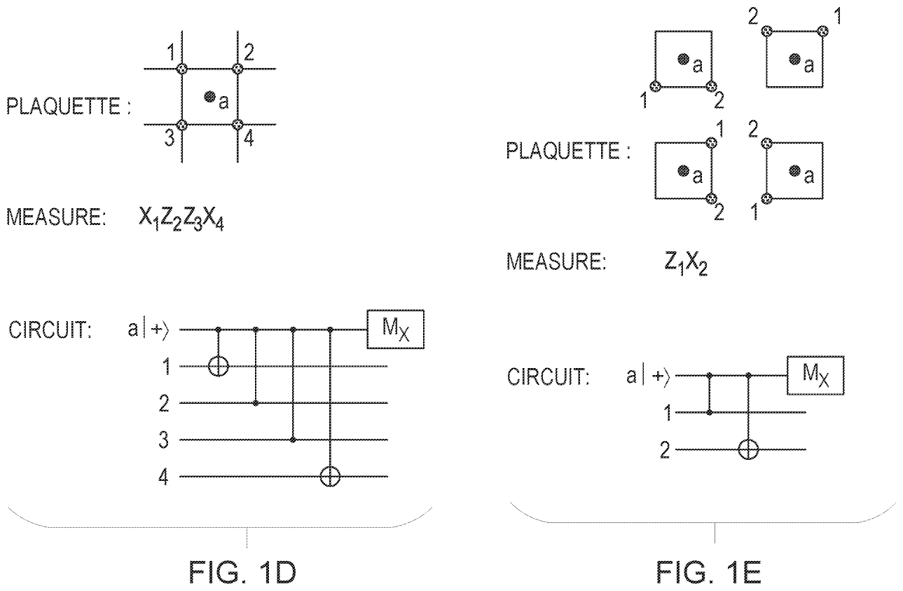

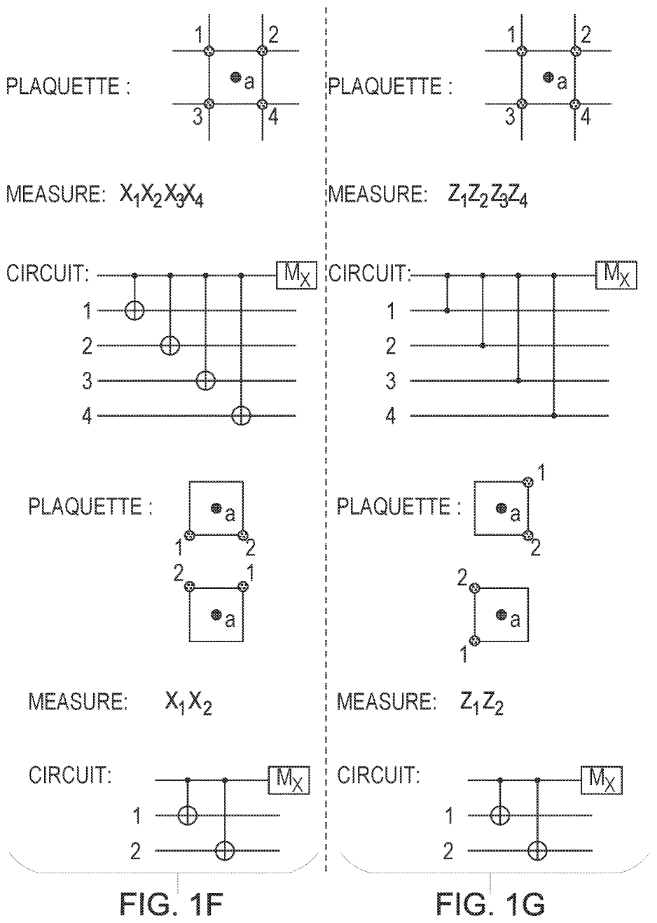

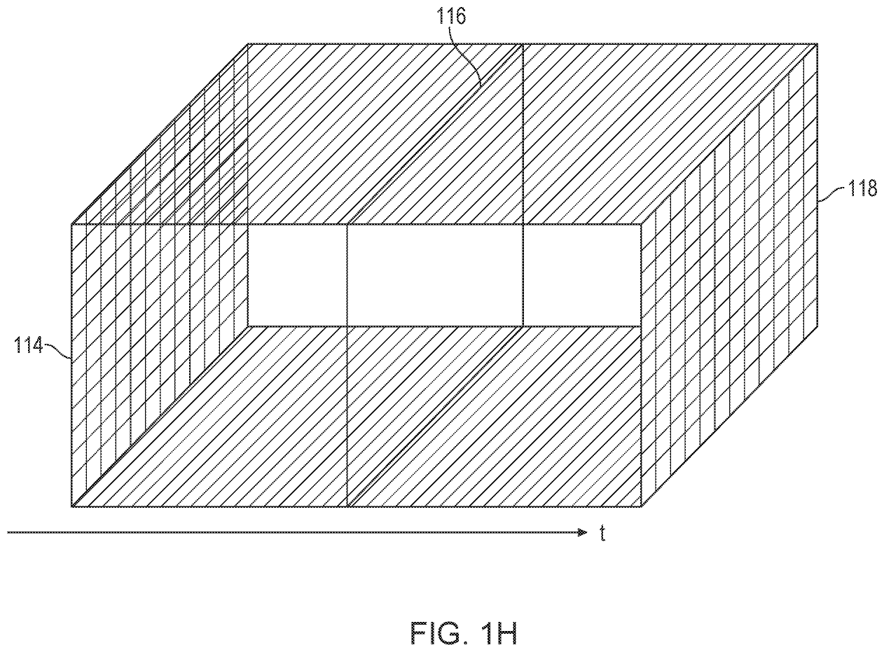

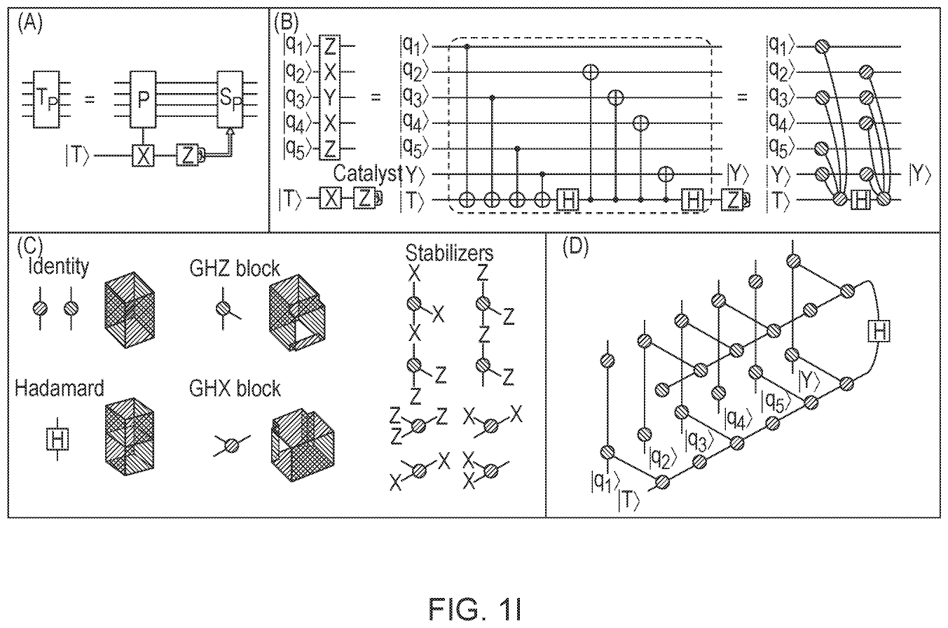

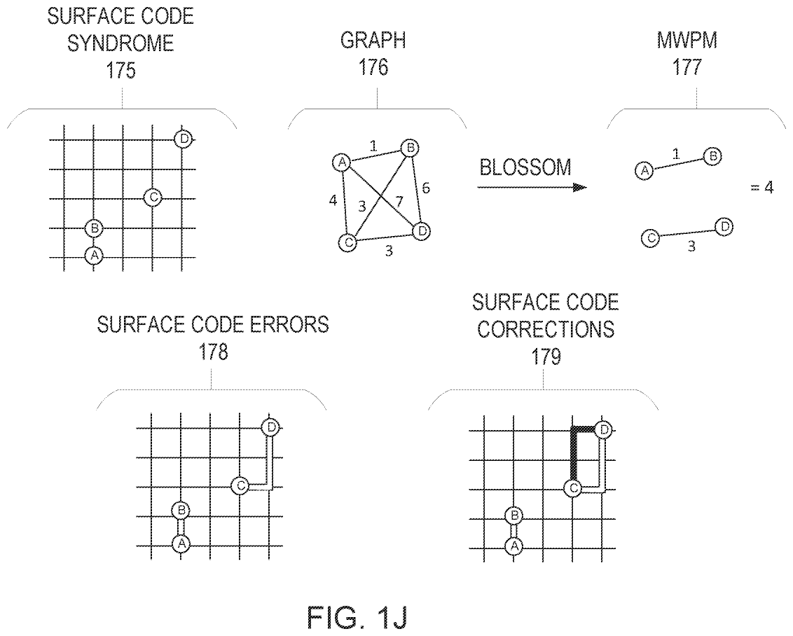

The following FIGS. 1A-1J discuss example configurations for quantum information processing systems, in accordance with some embodiments. Qubits: Quantum computing relies on the dynamics of quantum objects, e.g., photons, electrons, atoms, ions, molecules, nanostructures, and the like, which follow the rules of quantum mechanics. Generally, a “qubit” (or quantum bit) is a quantum system with an associated quantum state that may be used to encode information. A quantum state may be used to encode one bit of information where the quantum state space can be modeled as a (complex) two-dimensional vector space, with one dimension in the vector space being mapped to logical value 0 and the other to logical value 1. In contrast to classical bits, a qubit may have a state that is a superposition of logical values 0 and 1. More generally, a “qudit” describes any quantum system having a quantum state space that may be modeled as a (complex) n-dimensional vector space (for any integer n), which may be used to encode n bits of information. For the sake of clarity of description, the term “qubit” is used herein, although in some embodiments the system may also employ quantum information carriers that encode information in a manner that is not necessarily associated with a binary bit, such as a qudit.

Qubits (or qudits) may be implemented in a variety of quantum systems. Examples of qubits include polarization states of photons; presence of photons in waveguides; or energy states of molecules, atoms, ions, nuclei, or photons. Other examples include other engineered quantum systems such as flux qubits, phase qubits, or charge qubits (e.g., formed from a superconducting Josephson junction); topological qubits (e.g., Majorana fermions); or spin qubits formed from vacancy centers (e.g., nitrogen vacancies in diamond).

As used herein, a distinction is made between a “physical qubit” which is a physical quantum thing such as a molecule, atom, photon, etc. that exists in a 2-level quantum state, and a “logical qubit” which includes a plurality of physical qubits which function together (e.g., entangled) and can be encoded and managed according to a quantum error correcting code (such as a surface code).

Example implementations: Qubits (and operations on qubits) may be implemented using a variety of physical systems. In some embodiments of a photonic quantum computing system using dual-rail encoding, a qubit may be implemented using a pair of waveguides. In some embodiments, a photon in a first waveguide of the pair and no photon in a second waveguide of the pair (also referred to as a vacuum mode) may correspond to the |0 [symbol] state of a photonic qubit. Alternatively, a state with a photon in the second waveguide and no photon in the first waveguide may correspond to the |1 [symbol] state of the photonic qubit. To prepare a photonic qubit in a known logical state, a photon source may be coupled to one end of one of the waveguides. The photon source may be operated to emit a single photon into the waveguide to which it is coupled, thereby preparing a photonic qubit in a known state. Photons travel through the waveguides, and by periodically operating the photon source, a quantum system having qubits whose logical states map to different temporal modes of the photonic system may be created in the same pair of waveguides. In addition, by providing multiple pairs of waveguides, a quantum system having qubits whose logical states correspond to different spatio-temporal modes may be created. The waveguides in such a system need not have any spatial relationship to each other. For instance, they may be but need not be arranged in parallel.

Some embodiments described below relate to physical implementations of unitary operations that couple modes of a quantum system, which can be understood as transforming the quantum state of the system. For instance, if the initial state of the quantum system (prior to mode coupling) is one in which one mode is occupied with probability 1 and another mode is unoccupied with probability 1 (e.g., a state |10 [symbol] in the Fock notation introduced above), mode coupling may result in a state in which both modes have a nonzero probability of being occupied, e.g., a state a₁|10 [symbol] +a₂|01 [symbol] , where |a₁|²+|a₂|²=1. In some embodiments, operations of this kind may be implemented by using beam splitters to couple modes together and variable phase shifters to apply phase shifts to one or more modes. The amplitudes a₁ and a₂ depend on the reflectivity (or transmissivity) of the beam splitters and on any phase shifts that are introduced.

FIGS. 1A-1J: Logical Qubits A single physical qubit (e.g., such as the 2-level physical qubit illustrated in FIG. 1A with a quantum state |ψ [symbol] =a₁|0 [symbol] +a₂|1 [symbol] ) may in principle be used for quantum computation. However, individual physical qubits are susceptible to noise and decoherence. Generally, Fault-tolerant approaches utilize a plurality of entangled physical qubits to function as a single logical qubit where error corrections of readout data is applied to reduce error issues. In fault-tolerant approaches, a plurality of physical qubits such as those illustrated in FIG. 1B can be entangled together according to a specific error correcting code to produce a single logical qubit that is less susceptible to noise and decoherence. Encoding qubits in this manner causes the resultant logical qubit to be less sensitive to error and noise, and resultant errors may be fixed via quantum error correction. Encoding a logical qubit may itself be vulnerable to errors (e.g., incorrectly applying logical operator can result in a logical error, such as a vertical or horizontal line(s) in surface code).

In some quantum computing methodologies, such as fusion-based quantum computing and circuit-based quantum computing, a logical qubit is encoded from a plurality of physical qubits using a sequence of specific measurements (e.g., stabilizer measurements). The measurement sequence may be constructed where a subset of the physical qubits is measured (e.g., collapsing the quantum state and producing classical information, e.g., the measurement result) in such a way that the remaining unmeasured/un-collapsed degrees of freedom (e.g., a 2-dimensional subspace which has support over all the physical qubits) form the desired encoded logical qubit. Accordingly, the processes of performing stabilizer measurements and/or encoding a fault-tolerant logical qubit may receive a plurality of physical qubits as input and as output may produce both the encoded logical qubit and classical information (e.g., syndrome graph data) resulting from the measurement sequence.

In some approaches, the classical information is represented as syndrome graph data, where the syndrome graph is a geometric representation of the outcomes of the measurement sequence. Because the input physical qubits are prepared in an initial state and measured according to a predetermined measurement sequence, it may also be pre-determined how the syndrome appears in the absence of any errors involving the physical qubits during the measurement sequence (e.g., Pauli or erasure errors). Accordingly, any deviation of the syndrome graph data from the expected result may be indicative of one or more errors within the logical qubit. In general, these deviations may not indicate precisely which measurement(s) had an error, or which type of error has occurred, as there may be more than one type of error or combination of errors that is consistent with a given observed deviation from the anticipated error-free syndrome graph. For example, a syndrome graph may be determined as a grid of parity checks for adjacent nodes of the grid, whereby a parity error may indicate that one or more of the adjacent nodes had an error, but the parity error may not indicate precisely which adjacent node had an error, or which error occurred.

As used herein, the term “syndrome graph data” refers to a set of classical information (e.g., data represented by digital values such as ones and zeros) that specifies the location of one or more syndromes and/or one or more erasure errors within the syndrome graph of a logical block. A series of measurements (e.g., stabilizer measurements) are applied to the physical qubits of the error correcting code containing the encoded logical information, producing measurement outcomes as classical information. As described in further detail below, based on the knowledge of the particular geometry of the cluster state/error correcting code, these measurement outcomes may be used to determine classical data referred to herein as the “syndrome graph data.” The syndrome graph data may further include correction operators for the syndrome graph output by a decoder.

Errors that occur during operations on an encoded logical qubit may have varying degrees of severity. For example, errors in a logical qubit may cause logical failure if they link up in a way that spans the syndrome graph of the logical qubit. Conversely, localized errors that do not span the syndrome graph may be identifiable and correctable via quantum error correction.

FIG. 1B shows an arrangement of physical qubits that can be used to encode a fault-tolerant logical qubit using a surface code according to one or more embodiments. In FIG. 1B, the solid grid lines are guides to the eye and form an array of squares, also referred to herein as a “surface code”, with physical “data qubits” disposed on the four vertices of each square and physical “measure qubits” disposed on the face of each square. As used herein, measure qubits are the physical qubits which are measured to perform measurement checks on adjacent data qubits without directly measuring the data qubits and collapsing the quantum information. In this example the surface code has a length (e.g., code distance, fault distance) d of 12, but any length can be employed. In some embodiments, the buffer size to be added to the edge regions to suppress errors depends on the size of the code distance (e.g., which can depend on error performance of a given quantum computer and/or the quantum algorithm or application to be computed). In some embodiments, the buffer size added to the edge regions is dynamically adjusted by the modular decoder system 200 based on a given code distance (e.g., current code distance of a current quantum processing system set-up).

Continuing, in the example of FIG. 1B, the surface code arrangement of qubits also includes four lines of boundary measure qubits disposed adjacent to the outermost lines of data qubits. Each square is referred to herein as a plaquette. Within the bulk of the surface code (e.g., the plaquettes which don't form the outer boundary of the code) each data qubit may be coupled, via 4 two-qubit gates, to its 4 nearest neighbor measure qubits (each on four different plaquettes) and likewise, each measure qubit may be coupled, via 4 two-qubit gates to its 4 nearest neighbor data qubits. On the boundaries of the code, each boundary measure qubit may be coupled, via two two-qubit gates to its nearest adjacent data qubits. According to one or more embodiments, the two-qubit gates can be CNOT gates, CZ gates, and the like.

In order to operate the collection of data and measure qubits as a logical qubit that is protected against errors, the following set of measurements may be repetitively performed on the system. For each plaquette within the bulk of the surface code, 4-qubit stabilizers are measured. For example, as shown in FIG. 1D, if the data qubits of a given plaquette are labeled 1, 2, 3, 4 (e.g., data qubits 105, 107, 109, and 111) and the measure qubit is labeled a (e.g., measure qubit 103), the stabilizer to be measured can be X1Z2Z3X4. The “quantum circuit” (which is a term that refers to the sequence of gates and measurement operations to be performed on physical qubits) used to implement this stabilizer measurement is also shown in FIG. 1D and includes first initializing the measure qubit a in the |+> state, then performing the following gates: a CNOT gate between the measure qubit a and data qubit 1, respective CZ gates between the measure qubit a and qubit 2 and qubit 3, and a CNOT gate between the measure qubit a and qubit 4; followed by an x-basis measurement Mx of measure qubit a. The resulting measurement outcome (which takes the form of a classical bit, e.g., 0 or 1 or −1 or 1, depending on the choice of conventions) is equal to the outcome of the measurement of the parity check stabilizer X1Z2Z3X4 and becomes part of the syndrome graph. For the plaquettes found at the boundary of the surface code, and shown in FIG. 1E, a two-qubit stabilizer of the form Z1X2 is measured. The quantum circuit used to implement this two-qubit stabilizer measurement is also shown in FIG. 1E and includes first initializing the boundary measure qubit a in the |+> state then performing the following gates: a CZ gate between the measure qubit a and qubit 1 and CNOT gate between the measure qubit and qubit 2; followed by an x-basis measurement Mx of measure qubit a. In the example shown in FIG. 1C, there are two different types of boundaries depending on whether the boundary includes shaded plaquettes or unshaded plaquettes. A boundary surface that includes shaded plaquettes is referred to as a “dual boundary surface” and measurements including measure qubits within the dual boundary surface contribute to the “dual syndrome graph.” Similarly, a boundary surface that includes unshaded plaquettes is referred to herein as a “primal boundary surface,” and measurements including measure qubits within a primal boundary surface contribute to the “primal syndrome graph.”

To implement the surface code scheme shown in FIG. 1C-1E, the plaquette measurements may be broken into two groups of measurements: a first group of measurements that measures the stabilizers associated with the shaded plaquettes during a first duration of time and a second group of measurements that measures the stabilizers with the unshaded plaquettes during a second duration of time. These two sets of measurements are performed in different times to ensure that each qubit only participates in one quantum gate at a time. One of ordinary skill in the art will appreciate that any gates that can commute with one another may be performed in the same time step, or even simultaneously, if desired. The classical data generated by each one of these measurements, referred to herein as “syndrome graph data”, is then passed to a decoder for quantum error correction according to known methods, e.g., using union find decoding, minimum weight perfect matching or any other decoding process (e.g., belief propagation, neural network based decoding).

One of ordinary skill will appreciate that the example shown in FIG. 1C is using a particular choice of local basis for the surface code and that other choices for the basis may be employed. For example, in some contexts, taking certain assumptions from of the errors that may occur on the underlying data and measure qubits, one may apply a single qubit gate to each data qubit to obtain a modified surface code. One may modify the basis for each check to obtain a scheme for the modified code. One example includes the CSS (Calderbank, Shor, Steane) version, where stabilizer measurements are either x-type or z-type. To obtain this version of the surface code, the stabilizers are conjugated by a Hadamard H: X->Z, Z->X on half the data qubits in a bipartition, thereby resulting in the CSS surface code. Note that the measurement schedule described above remains the same, but the new stabilizers are given by that summarized in FIG. 1F and FIG. 1G.

If the above-described surface code measurement schedule is applied for numerous time steps, the system effectively acts as a quantum memory for the logical qubit encoded by the underlying surface code or, viewed another way, as a logical identity gate on the logical qubit that is encoded by the underlying surface code. Viewed yet another way, this process operates as a logical channel.

FIG. 1H illustrates a 3-dimensional graphical depiction of such a logical identity gate. The surface labeled 114 is the input to the gate and includes a logical state encoded in a surface code, represented as the input checkerboard surface. Likewise, the surface labeled 118 identifies the output qubits after the identity gate I has been applied to it. The input and output surfaces, which may be associated with the physical 2D arrangement of data and measure qubits described above, are connected to each other via an intervening volume that represents the unique set of measurements to be applied over time (e.g., at a given time, a slice or frame 116 corresponds to measurements applied at a given instant in time). Accordingly, in FIG. 1H, time flows from left to right and the lighter shaded (front and back) and darker shaded (top and bottom) sides of the boundaries of the volume depict whether the primal or dual plaquettes are disposed on that boundary as described above in reference to FIG. 1C-1E.

While FIG. 1H shows the logical identity gate, any gate can be depicted in this manner and such a depiction is one example of a “logical block” that specifies a set of instructions to be performed on the underlying surface code qubits to perform a logical operation (the Identity gate in this example) on the logical qubit that is encoded by surface code. Other examples of such gates are the S gate, the Hadamard gate, and the CX gate, as well as different types or representations of logical gates as discussed in FIG. 1I.

FIG. 1I shows example quantum instruction sets of different types and the correspondence between the different types, in accordance with some example embodiments. In the following, logical blocks are discussed as example logical gates, however it is appreciated by one of ordinary skill in the art, that logical qubits and gates can be implemented in a given system in different representations, such as those shown in FIG. 1I.

For example, Box A in FIG. 1I shows a quantum circuit for implementing an n-qubit Tₚ:=exp (iπ/8P) gate (e.g., a T-gate, a non-Clifford gate), for an n-qubit Pauli product operator P, by the inclusion of a magic state, along with a generalized CNOT operator controlled on P and conditional S_{P}:=exp(iπ/4P) gate (S-gate) conditioned on a qubit measurement on the injection register. In some embodiments, the conditional S_{P} can be accounted for by the Clifford frame tracking.

In the example of Box A, while the Z measurement has a single classical logical signal as output, it is appreciated by one of ordinary skill, it is not one single (physical) measurement, but in general a large collection of physical measurements and associated classical outcomes, which are decoded in real time (e.g., run time) to generate an error corrected logical outcome, and this decoded outcome is used to determine what S-gate should be applied. Generally, decoders to be applied should be fast enough (e.g., low enough reaction time) to receive the Z-measurement data and decode it quick enough to identify the S-gate operation, without causing or adding to decoder backlog, as discussed further below.

In FIG. 1I, Box B shows a generalized CNOT that is conditioned on P, which corresponds to quantum circuit notation (e.g., as shown in (dashed box), where the circuit includes sequence of CNOTs, and two Hadamard operators. The example decomposition uses a |Y [symbol] state (Y eigenstate) which is kept unchanged in the process (e.g., as a catalyst state). The circuit structure can be simplified into a ZX diagram (e.g., of ZX Calculus), which is shown in the right most portion in Box B. This ZX diagram corresponds to a 5-qubit Pauli operator P=ZXYXZ.

In FIG. 1I, Box C shows a correspondence of each element of a graph G_{log} (e.g., shown as a quantum instrument) which can be combined as a logical block. Stabilizers describing the quantum instrument are shown in the right side of Box C, where each one corresponds to a membrane in the logical block (e.g., the blue and red boundaries correspond to primal and dual boundaries.

In FIG. 1I, Box D shows a ZX-diagram that is equivalent to the one obtained for the 5-qubit example in Box B. The ZX diagram of Box D is also compatible with elementary logical blocks arranged in a local 3D structure (e.g., in a CNOT matrix architecture), in accordance with some embodiments.

FIG. 1J shows an example of surface code decoding, in accordance with some example embodiments. In the example illustrated, the decoding scheme being implemented is Minimum Weight Perfect Matching (“MWPM”; QSurface MWPM software package (https://qsurface.readthedocs.io/en/latest/decoders/index.html#mwpm), however it is appreciated that other decoders can likewise be implemented, such as Union Find decoding (Nickerson 2017, Quantum 5, 595 (2021)), Belief Propagation (BP), Neural Network based decoders, and so on.

Generally, in MWPM, a number of check errors (syndromes, excitations, X-check violations, Z-check violations) are identified on a surface code patch (e.g., a patch of a logical block layer). In the example of FIG. 1J, only X errors are discussed but it is appreciated that Z errors can be handled similarly (e.g., in a separate Z-subgraph). In Minimum Weight Perfect Matching, the decoder attempts to find a least-weight error chain that matches the readout data errors (e.g., the excitations, syndrome data). Here, the weight of an error could be, for example, the total number of non-trivial Pauli operator factors comprising the error chain, or modified to include individual weights based that depend on the probability of each elementary error. The solution can be formulated as a graph matching on a graph determined by the syndrome and the set of checks. In graph analysis, a graph G can include Vertices and Edges (e.g., G=(V, E)), and a graph matching involves determining a Matching (M) having edges (ME) such that no edges in ME share vertices each other. In other words, Matching M is a set of edges without common endpoints. The weights of the edges are the distance between the vertices. In Minimum Weight Perfect Matching, for a given Graph, G, there may be multiple perfect matchings possible, and the goal is to find the perfect matching that has a minimum weight. For instance, in each perfect matching, simply add up all the edge weights and the perfect matching with the smallest summed weights is the Minimum Weight Perfect Matching for that graph G.

With reference to FIG. 1J, a five by five example planar surface code 175 is shown with syndrome data (e.g., error readouts, checks), that are labeled as points A, B, C, and D. In the schematic 175 (similarly for 178, 179), the checks of the surface code are represented by a square lattice graph, where edges correspond to elementary error locations, and the vertices as their endpoints correspond to the checks they violate. In some example embodiments, the decoding problem takes place on a three-dimensional graph.

The syndrome data can be readily converted into a graph 176 where the vertices of the graph 176 correspond to the syndrome data points and the edges of graph 176 are distances (e.g., weights) between a given pair of connected vertices (e.g., Manhattan distance). Although different matchings may be possible, for brevity, only the minimum weight perfect matching 177 is shown for graph 176. In the minimum weight perfect matching 177, the sum of the matching A-to-B (1) and C-to-D (3) is 4, which is the smallest of any perfect matching for graph 176. For example, another perfect matching can include A-to-C (4) and B-to-D (6), however, that matching would not be a minimum perfect matching as 4+6 is 10, which is larger than 4 (the value of the AB+CD perfect matching). In some example embodiments, an algorithm, such as the Blossom Algorithm, can be applied to the graph 176 to yield the MWPM 177; though it is appreciated different matching algorithms exist and can likewise be implemented in place of Blossom.

The minimum weight perfect matching 177 corresponds to the smallest number of elementary errors that explain the syndrome, where the full predicted errors (e.g., according to matching 177) is shown as surface code errors 178, where a white line connecting A-to-B correspond to a first error chain and another white line connecting C-to-D corresponds to a second error chain. As shown in the corrections 179, the correction operator applied can correspond to the same white line connecting C-to-D, or alternatively, the correction operator can be the black line connecting C-to-D which function in a similar manner (e.g., as part of the same coset, as is understood in the art). Further, in some embodiments, the correction operator for A-to-B may be the same as the white line connecting A-to-B, or the errors connecting A-to-B may be ignored; for example, where the errors A-to-B are trivial and do not affect logical operations.

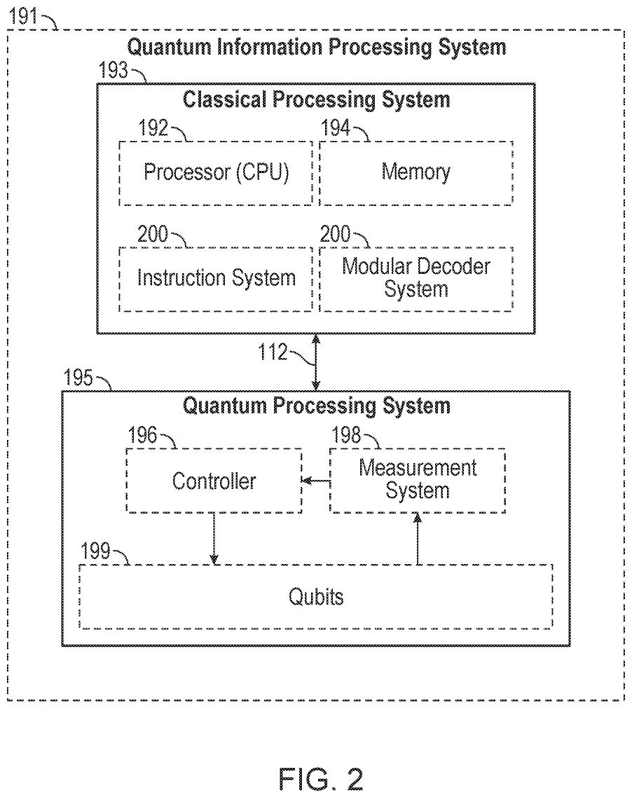

FIG. 2 illustrates a quantum information processing system 191, in accordance with some embodiments. As illustrated, the system includes a classical processing system 193 that is coupled to a quantum processing system 195 over a classical channel 112 (e.g., electrical or optical data lines). The classical channel 112 may relay classical information between the classical and quantum computing systems.

In some embodiments, the classical processing system 193 includes one or more non-transitory (or non-tangible) computer-readable memory media 104, one or more central processing units (CPUs) or processor(s) 192, a power supply, an input/output (I/O) subsystem, and a communication bus or interconnecting these components. The processor(s) 192 may execute modules, programs, and/or instructions stored in memory 194 and thereby perform processing operations. The processor may comprise a dedicated processor, or it may be a field programmable gate arrays (FPGA), an application specific integrated circuit (ASIC), or a “system on a chip” that includes classical processors and memory, among other possibilities. In some embodiments, memory 194 stores one or more programs (e.g., sets of instructions) and/or data structures and is coupled to the processor(s).

In some embodiments, the classical processing system 193 comprises an instruction system 203 that can receive user code (e.g., quantum application data, tasks, gates to perform) and schedule the data for processing and decoding on the quantum processing system 195. In some example embodiments, the next tasks that are issued by the instruction system 203 can depend on the decoded output from a modular decoder system 200. The modular decoder system 200 manages separating a global decoding task into smaller sub-tasks for efficient processing while maintaining sufficient error suppression and decoder soundness.

The classical processing system 193 may be classical in the sense that it operates computer code represented as a plurality of classical bits that may take a value of 1 or 0. Programs may be written in the form of ordered lists of instructions and stored within the classical (e.g., digital) memory 194 and executed by the classical (e.g., digital) processor 192 of the classical computer. The memory 194 is classical in the sense that it stores data and/or program instructions in a storage medium (e.g., non-transitory or non-tangible computer-readable storage medium) in the form of bits (rather than as qubits containing quantum information), which have a single definite binary state at any point in time. The processor may read instructions from the computer program in the memory 194 and/or write data into memory, and may optionally receive input data from a source external to the computer, such as from a user input device such as a mouse, keyboard, or any other input device. The processor 192 may execute program instructions that have been read from the memory 194 to perform computations on data read from the memory 194 and/or input from the quantum computing system, and generate output from those instructions. The processor 192 may store that output back into the memory 194.

The quantum processing system 195 may include a plurality of qubits and a controller 196 configured to interface with the plurality of qubits 199 to control, direct and/or measure the qubits within the quantum circuit. The qubits may be configured to evolve in time under the directed influence of the controller 196, and a measurement system 198 may at times perform quantum measurements on all or a subset of the qubits to obtain quantum measurement results in the form of classical data bits (e.g., ones and zeros). In some embodiments, the measurement system 198 comprises a plurality of measurement hardware, such as quantum hardware 313A-313N (e.g., photon detectors). The classical data from the measurement results may be intermediate results that inform behavior of the classical computing system and/or the quantum controller 196 during a quantum computation, and they may additionally include classical results of the quantum computation. The measurement results may be communicated to the classical computing system and/or the controller 196, and further the classical computing system may provide directions and/or instructions to the controller 196 and the measurement system 198 to guide the behavior of the quantum computing system to perform a quantum computation. For example, the classical processing system 193 may provide classical data signals used for quantum state preparation within the quantum processing system 195, in response to which the controller may prepare the states of the qubits 199 into a desired initial state for a particular quantum computation.

In some embodiments, qubits 199 (e.g., physical qubits) are provided to the measurement system 198 and controller 196, where the measurement system and the controller function as a logical qubit encoder that perform a sequence of measurements on the physical qubits to produce a logical qubit (e.g., a logical qubit prepared in a magic state, or another type of encoded logical qubit). For example, the measurement system and controller may perform a sequence of measurements on the physical qubits to entangle them in such a way as to produce a logical qubit. Encoding the logical qubit will also produce syndrome graph data for the logical qubit as classical information, which is output to the classical processing system 193 via the classical channel 112.

A more technical explanation is included here, before further discussing examples in the figures. Generally, classical outcomes (e.g., measurements) provide a mere classical window onto the quantum evolution of qubits in a quantum information processing system (e.g., quantum computer). Further, decoding involves the processing of raw classical data produced during a quantum computation (e.g., readout data, measurement data).

In some example embodiments, the collection of physical outcomes of a computation is indexed here by the set [symbol] . For simplicity, and in use in stabilizer formalism, it is assumed here that outcomes take on binary values denoted by v: [symbol] → [symbol] ₂ (with [symbol] ₂={0,1}). In some example embodiments, parity checks are constraints among the measurement outcomes reflecting the redundancy among them under ideal operations (e.g., in the absence of errors). In stabilizer formalism of fault tolerant approaches, a check σ is characterized by a sub-set of outcomes with a fixed joint parity (which can assumed here to be 0 without loss of generality). In some embodiments, where the definition of v is extended linearly over subsets of [symbol] , the constraint is denoted as v(σ)=0. A value of v(σ) other than 0 indicates the presence of errors. In some embodiments, in the context of stabilizer fault tolerance, the set of all checks <Σ> has the structure of a linear space generated by a given set of check [symbol] Σ [symbol] has the structure of a linear space generated by a given set of check generators Σ (i.e., [symbol] Σ [symbol] =span (Σ)). Further, [symbol] Σ [symbol] is a linear subspace of the power-set [symbol] ( [symbol] ) of [symbol] , the set of all possible subsets of [symbol] which can be interpreted as the linear space [symbol] (the space of functions from [symbol] to [symbol] ₂). In other words, [symbol] Σ [symbol] is closed under exclusive or (XOR) of its elements (e.g., σ₁∈ [symbol] Σ [symbol] and σ₂∈ [symbol] Σ [symbol] implies σ₁⊕σ₂∈ [symbol] Σ [symbol] ). In this way, the information which is relevant for the decoder units to identify an error is contained in v [symbol] (e.g., by way of restriction of v to elements in [symbol] Σ [symbol] ). This information can be encoded in the resulting parities for the, possibly over-complete, generating set of checks Σ. In some example embodiments, the modular decoder system 200 has access to data describing the set of checks Σ as well as their syndrome outcome v:Σ→ [symbol] ₂ as they become available from readout or measurement devices (e.g., photon detectors, antennas, imaging devices, and so on).

In some embodiments, check generators in Σ can impact the performance of the decoder, and can effectuate locality can be used for decomposition of the decoding tasks for the decoders (e.g., scheduling). In some example embodiments, it is possible for check generators at a higher level to be treated as logical outcomes by a lower level error tolerance scheme. Magic state distillation is a practically relevant example of such a situation. In the magic state distillation approach, physical injected states are unprotected by the underlying low level surface code style fault tolerance. However, the distilled magic states are nevertheless protected by higher level distillation checks.

In some example embodiments, logical outcomes are the final product of a logical processing of a quantum instruction set. In the desired regime of operation, these logical outcomes reproduce and/or approximate the same value distribution as a noiseless quantum computer. Logical outcomes [symbol] are derived from physical outcomes in [symbol] . In some embodiments, logical outcomes M∈ [symbol] take bit values. Moreover, in the absence of errors their value v(M) is the joint parity of a corresponding subset of outcomes M⊂ [symbol] , which gives the ideal logical outcome distribution taken as reference. The choice of letter, [symbol] , is intended to convey membrane, which correspond to the 2D arrangement of physical outcomes associated to logical outcomes.

In surface-code based approaches, logical outcomes correspond to relatively closed membranes. In some embodiments, a membrane is relatively closed if (at some point in the computation) its support is fully contained within the set of available outcomes (e.g., it will have no support on outcomes to be generated in the future). In general, the entirety of a logical membrane can be a computationally unwieldy object, spanning and branching through (potentially the entirety of) the computation. The logical Pauli frame can be a convenient way to practically handle the complexity. In some embodiments, the Pauli frame summarizes the parity accumulated by partial logical membranes which may or may not, in the future, be completed into a logical outcome of [symbol] . In a snapshot of the computation, there would be one partial logical membrane per element of the instantaneous n-qubit logical Pauli group (with n equal to the number of logical qubits at that instant in time); these are the bits of the Pauli frame. This approach provides the flexibility of defining the logical circuit on the go. When, completing a logical measurement (e.g., by closing a membrane M), the outcome v(M) can be obtained by taking a joint parity of the historic parity of M, as given by a corresponding Pauli frame element with a recent term associated to the closure of M.

In some embodiments, partition of historic and recent is processing and data can be arbitrary but serves a practical purpose. For ideal noiseless operations, each bit of the Pauli frame simply accumulates the partial outcome parity for some partial membrane M. In noisy qubit computations, this parity may implement adjustment in order to compensate the effect of diagnosed errors on the logical Pauli frame.

Error models: In some embodiments, the error model is here defined in terms of a set of elementary errors or faults e∈ε which are Pauli (product) operators acting on the qubits at different times throughout the computation. This choice is motivated by the fact that for stabilizer-based approaches, the (Pauli) measurements used to generate the parity checks collapse many coherent errors into Pauli errors, and thus the effects of a wide range of errors can be modeled in this way. The choice of elementary errors ε is model specific and should aim to represent the physics and imperfections of the device(s) being modeled. In some embodiments, the error generators ε a one-to-one relation between physical measurement outcomes o∈ [symbol] and each error generator e∈ε, with each element e flipping a single outcome o.

In some embodiments, [symbol] ε [symbol] denotes the possible combinations of elementary errors in ε, and ∈∈ [symbol] ε [symbol] is implemented to denote the unknown error combination occurring on the quantum state system. Further, the probability of different errors ∈∈ [symbol] ε [symbol] occurring can be described by an independent probability distribution (or possibly a low correlation distribution) on elementary error generators e E E.

In a quantum instrument network (QIN), composed of stabilizer instruments (a generalization of Clifford maps including measurement, the effect of inserting Pauli errors between instruments is to flip a set of outcomes. Specifically, there is a linear relation which determines which checks σ∈ [symbol] Σ [symbol] and logical membranes M∈ [symbol] are flipped by a given error ∈∈ [symbol] ε [symbol] . This relation can be denoted by the bi-linear map ∂, with ∂∈: [symbol] ε [symbol] → [symbol] ₂, along with ∈_{M}: [symbol] → [symbol] ₂, which are themselves linear in ∈∈ [symbol] ε [symbol] . Thus, a specific error ∈ flips a well defined set of logical outcomes specified by the indicator function [symbol] , where the task is set to identify which these are without knowing ∈.

Generally, decoding consists of accurately inferring [symbol] by using the prior distribution of ∈ as well as its signature over the available syndrome information ∂∈=v|_{Σ}. Decoding schemes (e.g., minimum weight perfect matching, Union Find) can approach this problem by inferring a recovery operator κ which also belongs to [symbol] ε [symbol] . As such, it also has associated linear maps ∂κ and [symbol] . The decoder will be successful if it can identify a correction κ such that [symbol] = [symbol] . Note that this is a much weaker requirement than κ=∈, which is not necessary for successful decoding. However, since decoders do not have access to [symbol] they pick a recovery operator κ with relatively high likelihood such that ∂κ=∂∈ (e.g., the recovery operator κ has exactly the same syndrome as the error ∈). In other words, applying the combination of error ∈ and recovery κ leads to all parity checks in Σ being satisfied (e.g., a trivial syndrome). Note however, that only [symbol] and not the entirety of κ is the relevant information produced by the decoder. In a real-time decoding process, this allows efficiently summarizing partial decoding progress by keeping track of the effect of κ on partial membranes with an error-corrected Pauli frame. The following is used here: ∈ is the physical error configuration, and κ: the global correction chosen by the decoder.

Code distance (e.g., fault distance) is a quantity that can characterize the noise resilience of a given protocol. The code distance may depend only on the error generators ε and its relationship with the logical outcomes [symbol] and the space of checks Σ but is independent of the decoder. In some example embodiments, an error ∈∈ [symbol] ε [symbol] is held to be undetectable, if it has a trivial syndrome (e.g., ∂∈=0). The weight of an error operator e∈ [symbol] ε [symbol] denoted by |∈|, is the smallest number of elementary faults e∈ε needed to express ∈ (e.g., as ∈=e₁e₂ . . . e_{|∈|}). In some example embodiments, the fault distance d of a protocol, is the weight of the smallest non-trivial undetectable error (e.g., the smallest |∈| such that ∂∈=0 but [symbol] ≠0). In other words, it is the weight of the smallest undetectable error giving rise to a change in a logical measurement outcome.

It is noted that the weight is dependent on the error model of interest through the set of elementary error generators ε. If a decoder with effective fault distance of d over a fault-tolerance protocol, can detect any error of weight up to d−1 and can correct any error with weight up to

$$⌊ \frac{d - 1}{2} ⌋ .$$

As used here, a decoding system is sound with respect to the protocol of distance d, if the decoder also has an effective fault distance d; whereby soundness can assure accurate decoding. In other words, decoder soundness is here a decoding system produces a minimum weight correction κ for any (physical) error ∈ with |∈|<d/2, where d is the fault distance of the protocol. In this way, a decoding system satisfying the soundness condition will correctly recover from any physical error configuration ∈∈ [symbol] ε [symbol] with |∈|<d/2.

Examples of sound decoding schemes include minimum weight perfect matching and union find; which are sound in a given protocol as long as the relation ∂ between error generators ε and check generators Σ is accurately captured by a syndrome graph. Syndrome graphs are a useful data structure to represent the decoding problem whenever each elementary error ε∈ε flips at-most two parity checks σ∈Σ. This leads to a graph structure with check generators Σ corresponding to vertices of the graph and elementary errors e∈ε E flipping a given pair of check generators corresponding to edges between corresponding the vertices of the graph. Syndrome graphs can be defined differently in different approaches, such as surface code (e.g., for Pauli and measurement based approaches), cluster states, fusion ring networks, or tanner graphs.

In the tanner graph approach, with respect to connected error clusters, the check generators Σ and error generators ε together with their anti-commutation relations ∂ define a Tanner graph. This is a bipartite graph with each node representing either a check generator σ∈Σ or an error generator e∈ε and edges between them used to represent the relation ∂e(σ)=1. In some embodiments, two error generators e₁ and e₂ are directly connected if they are distance 2 in the Tanner graph (e.g., there is at least one check generator σ s.t. ∂e₁(σ)=1 and ∂e₂(σ)=1).

In some example embodiments, given an error configuration ∈ we may use this notion of connectedness to partition it into connected components. Each of these can be implemented as components of a connected error cluster. In the case of syndrome graphs, this notion coincides with viewing ∈ as a sub-graph (subset of edges) of the syndrome graph and identifying its connected components. The rationale behind this definition is that if ∂∈=0 and ∈ has connected components ∈ᵢ, then ∂∈ᵢ=0. In other words, an error configuration ∈ is undetectable, if and only if, all of its connected components are undetectable. For this reason, lowest weight undetectable logical errors will always consist of a single connected error cluster.

Modular decoding: As discussed, it can be difficult to decode outcome data in a high-speed scalable manner. The following discusses approaches in accordance with some example embodiments for modular decoding. In the following, logical blocks are discussed as examples, though as mentioned above, different types of logical gate representations can be implemented in a similar manner. At a high level, a logical block network defines a class of decoding problems (Σ, [symbol] ,ε), with their relation ∂ and possibly a probability distribution over [symbol] ε [symbol] . A specific problem instance can be given by the syndrome configuration ∂∈ corresponding to a physical error ∈∈ [symbol] ε [symbol] . Further details are discussed below showing how to divide the decoding problem of a network (or part of one) into smaller decoding sub-tasks, which can be solved separately-some in parallel—and then combined to solve the global problem.

Decomposition of modular decoding tasks: Modular decoding addresses the decoding problem of providing logical outcomes throughout in run time computation by splitting the monolithic problem into decoding sub-tasks of manageable size. The solution to each sub-task includes a portion of the global recovery κ. In some embodiments, these tasks can begin as soon as their input data is available. Furthermore, as soon as the necessary outcomes and portions of x are available error corrected logical outcomes v̅(M):=v(M)⊕ [symbol] (M) can be generated. This allows quantum processing to incorporate feed-forward classical control wherein the logical block structure of the computation changes depending on the extracted classical outcomes (e.g., conditional S gate, as discussed above in FIG. 1I).

In some example embodiments, the decoder proceeds by finding a recovery operator κ∈ [symbol] ε [symbol] , with the property ∂κ=∂∈. The approach taken by modular decoding is to split this problem into decoding sub-tasks indexed by i∈ [symbol] , with each task committing a portion κᵢ of the global correction κ

$$κ := {\sum }_{i ∈ 𝒯} {κ}_{i}$$

Obtaining each component κᵢ: Each decoding task i∈ [symbol] is defined by its own set of check generators Σᵢ⊆Σ, and error generators εᵢ⊆ε. The check generators Σᵢ and error generators εᵢ defining different decoding tasks can partially overlap in general. As used here, ∈ᵢ∈ [symbol] εᵢ [symbol] is the portion of the physical error configuration relevant to decoding task i∈ [symbol] . Further, μᵢ∈ [symbol] εᵢ [symbol] is the correction estimate produced by task i∈ [symbol] . Further, κᵢ∈ [symbol] Cᵢ [symbol] is the portion of the correction estimate μᵢ committed as part of the global correction κ by task i∈ [symbol] .

In some example embodiments, the result of each decoding task i is a recovery estimate μᵢ∈ [symbol] εᵢ [symbol] . In some embodiments, not all of the correction operator μᵢ is taken at face value and committed into the final correction κ. Only the restrictions of recovery estimate μᵢ to the smaller commit region Cᵢ are used to determine the final correction κ. Having a sufficient buffer can affect practical decoding performance, as otherwise the low-weight errors may lead to logical faults.

In some example embodiments, the global recovery operator κ is obtained by taking portions κᵢ of these recovery estimates μᵢ (i.e. κ|cᵢ=κᵢ:μᵢ|cᵢ). ¹ The commit regions Cᵢ partition the full set of error generators ε into disjoint subsets

$$ℰ = {⋃}_{i ∈ 𝒯} {C}_{i}$$

In turn, each commit region Cᵢ⊆εᵢ⊆ε is a subset of the error generators εᵢ relevant to decoding task i, with

$${ℰ}_{i} = {C}_{i} ⋃ {B}_{i}$$

The remaining set of error generators Bᵢ=εᵢ\Cᵢ relevant to each decoding task is called the buffer region for task i and improves the quality of κᵢ.

Decoding Dependencies: In some embodiments, to obtain a consistent recovery operation κ such that ∂κ=∂∈ decoding tasks communicate with one another, however such communication should be minimized to allow the decoders to function as independently as possible. In some embodiments, there are check generators σ∈Σ which straddle two (or more) commit regions Cᵢ, Cⱼ (e.g., there exists error generators eᵢ∈Cᵢ and eⱼ∈Cⱼ such that ∂eᵢ(σ)=1 and ∂eⱼ(σ)=1). Decoding of these tasks will need to coordinate to guarantee ∂(κᵢ+κⱼ+∈)(σ)=0. These decoding tasks i, j∈ [symbol] function as check neighbors and are communicated to different modular decoder units.

In some example embodiments, the communication between decoder units is implemented by adapting the input instance of some tasks based on the outputs/solutions obtained for other tasks. This preserves the functional input-output signature assumed from off-the-shelf decoding algorithms. In some example embodiments, this approach can limit neighboring decoding tasks from being solved in parallel (otherwise their combined recovery may not satisfy checks straddling both commit regions). As such, a sequential causal order can be implemented between all neighboring decoding tasks.

In some example embodiments, ordering between decoding tasks can be modelled with a scheduling graph G_{sch}:=( [symbol] , [symbol] ). This is a directed, acyclic graph (DAG), with vertex set given by [symbol] (e.g., one vertex per decoding task). A directed edge is placed between each pair of neighboring tasks i [symbol] j with the direction denoting the dependence of the input of j on the output of i. Tasks can only be consistently ordered if the graph is acyclic (not have directed cycles).

In some example embodiments, the scheduling graph can partly determine the reaction time—the computational contribution to the reaction time is upper bounded by the depth of the scheduling graph multiplied by the (maximal) time taken for a sub-decoder to return a recovery.

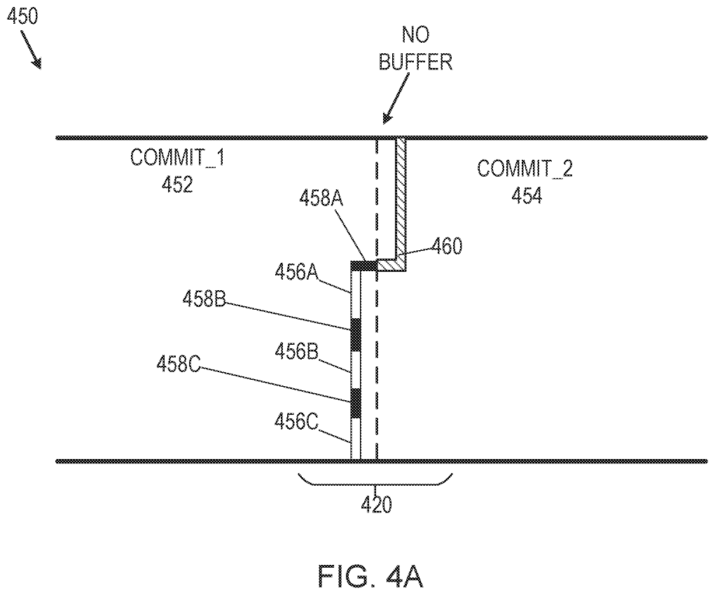

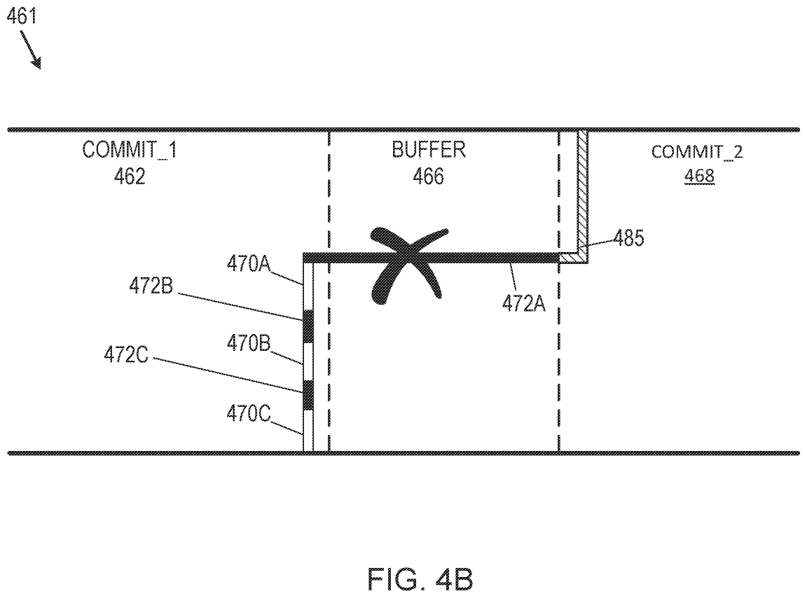

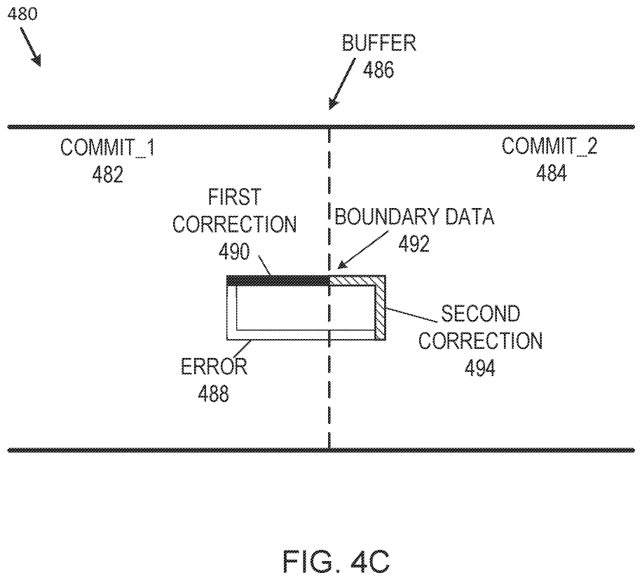

The set of visible syndromes, provided as input for a decoding task j, may be altered based on the output from other decoding tasks i preceding it (i [symbol] j). In particular, instead of the syndrome ∂∈ which only includes the effect of the physical errors ∈, the input instance to decoder j will consist of the syndrome ∂(∈+κ_{P}_{ⱼ}), where κ_{P}_{ⱼ}= [symbol] κᵢ includes the corrections committed by all prior decoders. In practice, Σⱼ will not include check generators which are already guaranteed to be trivial for κ_{P}_{ⱼ}+∈ and only a small number of check generators in Σⱼ are affected by corrections in neighboring tasks and thus will have their syndrome updated in the input to task j. This can be viewed as setting a boundary condition for task j. Updating at the boundary is further discussed with reference to FIG. 4C below (e.g., reference number 492).

Global parities and logical outcomes: For each commit region Cᵢ a sub-decoder commits a fragment κᵢ of the global recovery κ∝ [symbol] . In particular, the recovery's effect on logical membrane M is given by the map [symbol] (M)= [symbol] [symbol] (M). A specific membrane M∈ [symbol] can only have a finite subset of tasks [symbol] (M)⊆ [symbol] which can ever contribute to this sum (an intuitive reason for this is that outcomes are not affected by later errors). The subset the relevant tasks is referred to as M, and denoted by [symbol] (M):={i∈ [symbol] |∃e∈Cᵢ: [symbol] (M)≠0}. Once all outcomes for M are available and relevant decoding tasks completed, the corrected logical outcome for M can be determined by the (mod 2) sum of all partial membranes across the commit regions,

$$\overline{v} ( M ) := v ( M ) + {\sum }_{i ∈ 𝒯 ( M )} {κ}_{i ℳ} ( M )$$

where v̅(M) denotes the error corrected outcome for M. In some example embodiments, the uncorrected outcome v(M) can also be decomposed into partial membrane contributions along a similar partition.

Buffer growth and sizing: To keep the decoding tasks small and reaction time as low as possible, the size of the decoding sub-tasks must be as small as possible without impacting decoding quality. In some embodiments, a buffer region of width b≥d (or close to it) is determined using traversal analysis such that the decoding quality of monolithic decoding is maintained. In this section, minimal buffer regions Bᵢ:=εᵢ\Cᵢ are described, and well as the set of relevant check generators Σᵢ for each decoding task i∈ [symbol] can be obtained extracted automatically. In some embodiments, the only input needed is the partition of ε into commit regions Cᵢ, the desired buffer distance b and the partial order [symbol] among decoding tasks.

In some embodiments, from each commit region Cᵢ, a graph traversal (e.g., breadth first search) is performed into other error generators of ε. The graph structure used is the neighbor relation induced by the check generators Σ. However, error generators in Pᵢ are not included in the growth phase. This graph traversal collects all error generators at a graph-distance smaller or equal than a predefined buffer size b and adds them to Bᵢ if they do not already belong to Cᵢ. Since Pᵢ does not participate in the graph traversal, past commits act as a barrier to the buffer growth. As such, error generators which are a short distance from Cᵢ in the full syndrome graph (or Tanner graph), may end up being excluded due to past commits in Pᵢ.

In some embodiments, the same growth process can also be used to identify the check generators Σᵢ, which should be actively considered in the decoding task. The check generators in Σᵢ are those whose syndrome is fully determined by Pᵢ∪Cᵢ∪Bᵢ and not fully determined by Pᵢ. Note that by definition, the growth phase does not proceed into Pᵢ and check generators whose syndromes are fully determined by Pᵢ should already be neutralized by previous commits κ_{P}_{ᵢ}.

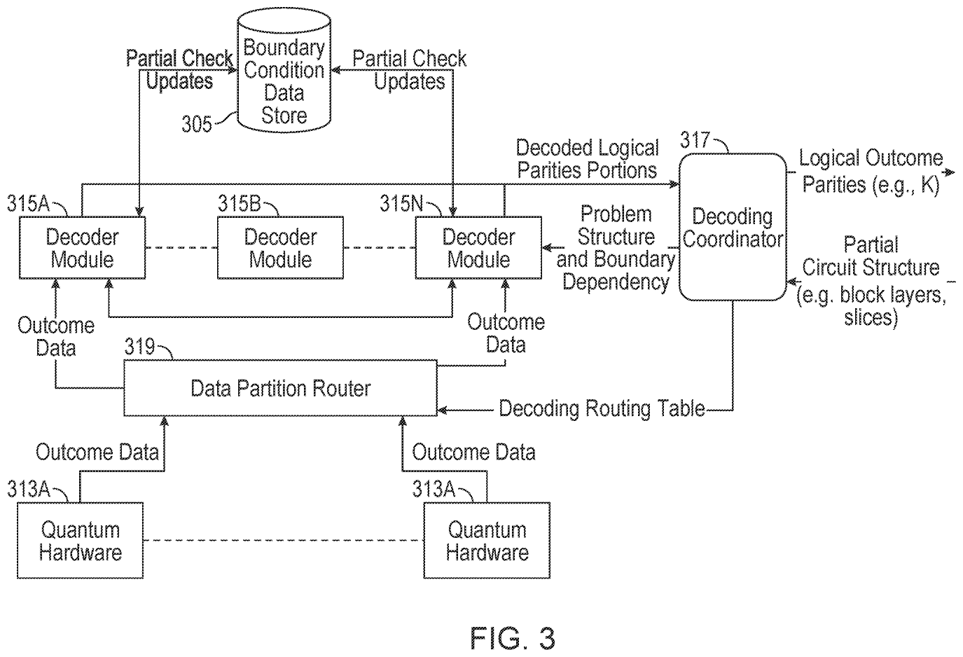

FIG. 3 shows an example implementation of the modular decoder system 200, in accordance with some embodiments. In the example of FIG. 3, some components may be external to the modular decoder system 200, such as quantum hardware modules 313A-313N (e.g., measurement devices), which can be implemented as instances of measurement system 198 (measurement devices).

In some example embodiments, the decoding coordinator 317 receives layers of scheduled data to organize and partition readout data using the data partition router 319. In some example embodiments, the decoding coordinator 317 implements scheduling data to generate routing table that is stored with the data partition router 319. The data partition router 319 receives the outcome data (e.g., readout data, measurement data) from a plurality of measurement devices of the quantum hardware modules 313A-313N and distributed the outcome data to the decoder modules 315A-315N based on the routing data. As discussed in further detail below, the data distributed to the decoders 315A-315N can include first commit data having buffers and second commit data. In some example embodiments, one or more decoders can store partial check update data (e.g., boundary data) in a boundary condition data store 305 for use by other decoders in decoding data sets of second commit data (e.g., vertex data). In some example embodiments, each of the decoder modules 315A-315N is implemented by a classical processor, such as a CPU, GPU, FPGA, or ASIC. In some example embodiments, the decoding coordinator generates the logical outcome data which can be returned to the instruction manager to determine next steps (e.g., how to implement the S-gate for distillation based on decoding of a Z gate, as discussed above with reference to Box A, FIG. 1I).

FIG. 4A-4C show example decoding processing, in accordance with some example embodiments. FIG. 4A shows example decoding data 450 for decoding, in accordance with some example embodiments. The decoding data 450 can correspond to surface code data or slices of a logical block. In the example of FIG. 4A, no buffer is implemented and partitioning the data into commit regions 1 and 2, without buffers, with commit_1 decoded before commit_2 leads to a logical error 420 (e.g., a vertical line comprising errors and corrections that connect the top and bottom of the decoding data 450, a logical X error).

In the example of FIG. 4A, the decoding data 450 is partitioned into commit_1 region 452 which is adjacent to commit_2 with no buffer in between them. Errors 456A-456C have occurred in commit_1 region 452 and the decoder generates corrections 458A-458C. Next the commit_2 region 454 is decoded which generates correction 460 which, taken together, creates a vertical line, which corresponds to a logical error (e.g., communication of the correction from 1 to 2 is passed along the boundary, yielding an updated syndrome between correction 458A and correction 460).

FIG. 4B shows a buffer being implemented, in accordance with some example embodiments. Similar to FIG. 4A, the decoding data 461 comprises data to be decoded by a decoding scheme (e.g., MWPM, Union Find), and the data is decoded partitioned into commit_1 region 462, buffer 466, and commit_2 region 468. Further, errors in commit_1 region 462, are shown by 470A-470C. In contrast to FIG. 4A, the decoder unit decodes commit_1 region 462 along with the buffer 466, which causes the decoder to avoid generating correction 472A as an output (as indicated by the X marking out correction 472A). For instance, in minimum weight perfect matching-based decoding (e.g., a graph matching approach), generating a correction 472A would not likely be part of a minimum weight graph matching solution (e.g., because correction 472A is so long, it would not be included in a minimum weight graph matching solution). Further, in turn, correction 485 would likewise not be generated by the next decoder. Instead, a minimum weight perfect matching-based decoder would more likely generate a correction given by the errors 470A-C; for example, corrections 472B and 472C may be output as corrections (e.g., or no corrections are output, where errors 470A-470C are predicted to be trivial).

FIG. 4C shows example decoding data 480 in which the data is separated by the buffer 486, however the buffer 486 is not illustrated to show the collective corrections more clearly. In the example of FIG. 4C, the decoding data 480 comprises commit_1 region 482, buffer 486 (between the commit regions and not illustrated), and commit_2 region 484. In the example of FIG. 4C, an error 488 has occurred in the commit_1 region 482 and upon decoding, the decoder generates first correction 490. The first correction 490 may include data that goes into the buffer region, however the buffer region correction data is ignored or discarded. Instead, the decoded data of the first commit region 482 is used as updated boundary data 492 (e.g., syndrome update) which the second decoder decoding commit_2 region 484 uses in its decoding processes. For example, a second decoder (decoder module 315B) applies the decoding scheme seeing its portion of the error 488 that is located in the commit_2 region 484 and also seeing the updated boundary data 492 as generated by the first decoder (decoder module 315A). In response to the error and boundary data, a second correction 494 is generated, whereby the first correction 490 and second correction 494 do not cause a logical error (no vertical line, no horizontal line).

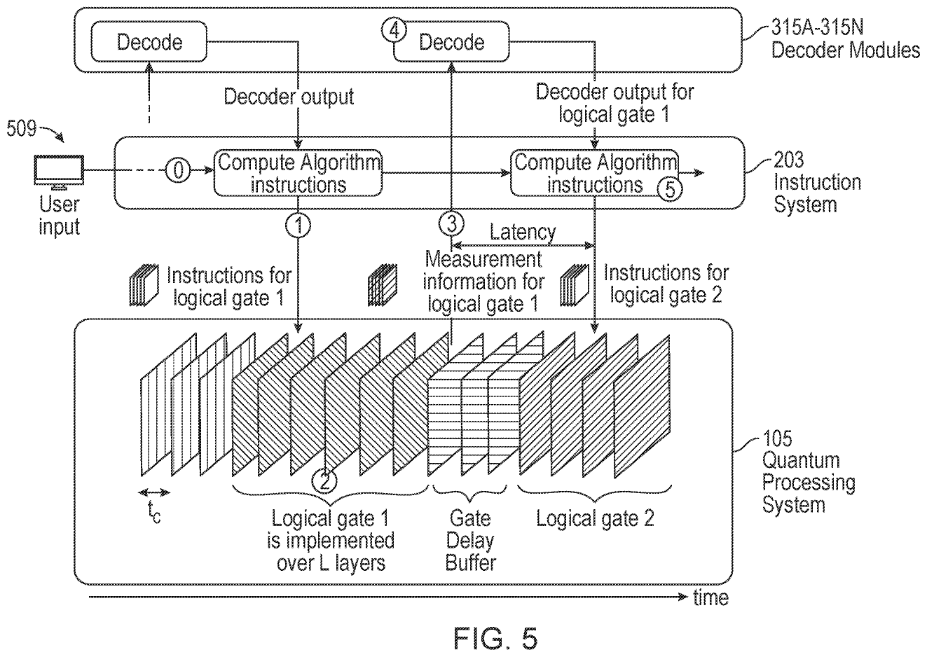

FIG. 5 shows an example an schematic diagram of the classical information (e.g., electrical binary data) flowing into and out of a quantum system, in accordance with some example embodiments. This diagram shows the evolution of a system over time as two logical gates (e.g., Logical Gate 1, Logical Gate 2) are implemented. Here we consider the example of topological quantum computation where a 2D layer of measurement information is obtained in each timestep. In FIG. 5, the quantum processing system 195 processes quantum objects to conduct quantum information processing. The quantum processing system 195 can receive and execute measurement instructions (e.g., via controller 196) to implement fault tolerant operations using the different logical gates.

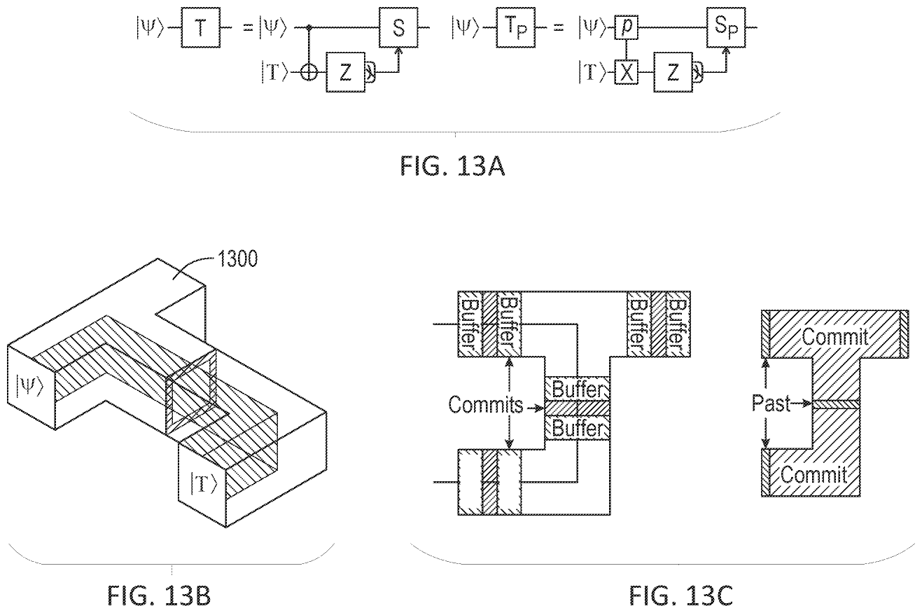

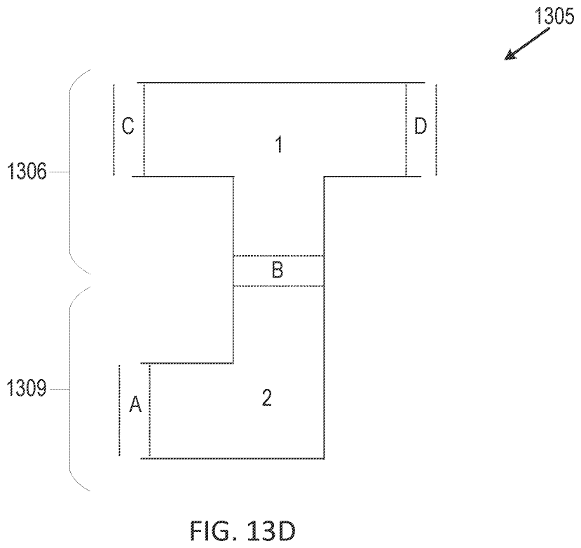

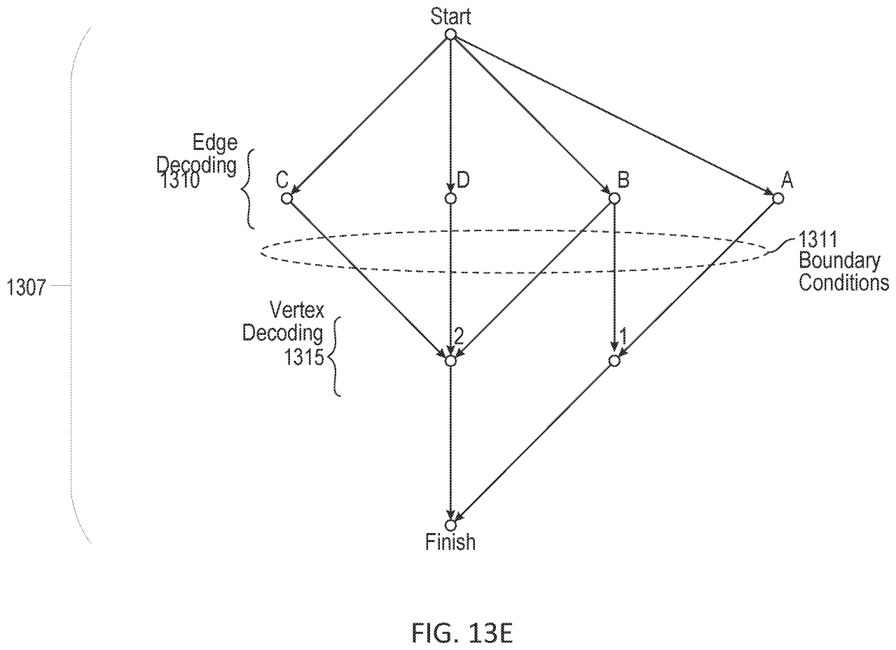

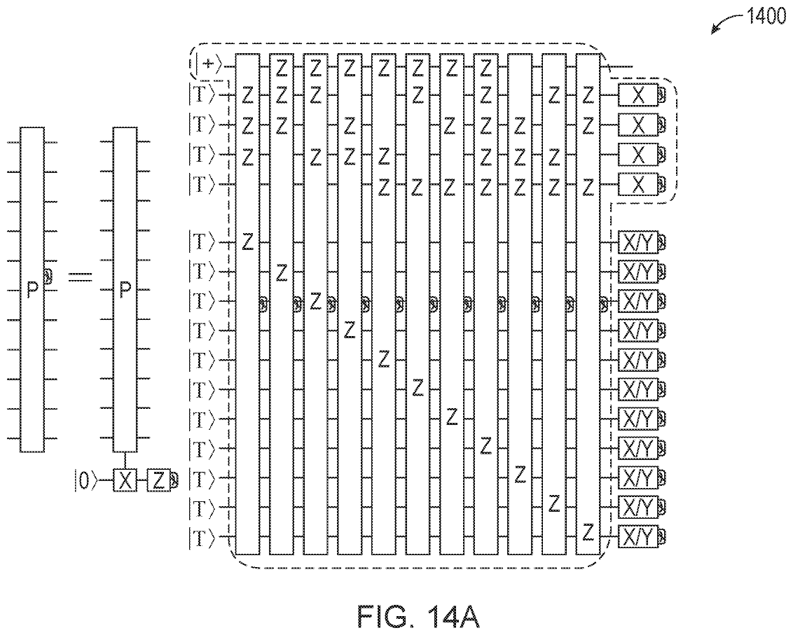

The instruction system 203 (e.g., a logical gate control system) contains the program for the quantum algorithm to be executed. In some embodiments, the instruction system 203 stores instructions for logical gates, and feedforward instructions about which gates to implement based on previous measurement results (e.g., magic stage injection, discussed below with reference to FIG. 13A-13E). This receives output from the decoder and sends logical gate instructions to the quantum processing system 195.

The decoder modules 315A-315N of the modular decoder system 200 can receive measurement information from the quantum processing 195 system and perform classical computational tasks (e.g., on a classical computer) to decode this data. The modular decoder system 200 then sends its output to the instruction system 203 or to the user upon completion of the quantum application being executed.

Information flow: We can understand the flow of information with the following steps, which are indicated in the figure by the numbered circles. At step 0, the instruction system 203 contains a quantum instruction set (e.g., list of tasks, gates in a circuit). In some embodiments, the quantum program comprises user input data 509 (e.g., input by a user on a user device, such as a laptop or desktop computer). In some embodiments, the user input data can be compiled offline (e.g., before the runtime of the quantum processing system 195) for conversion to logical instructions for execution on the quantum processing system 195. The quantum program may contain feedforward steps where future instructions depend on measurements made on the quantum system. After some number of steps of the program have already been executed the logical gate control has a current program state. First, instructions are issued by the instruction system 203 and sent to the quantum processing system 195.

The instructions are executed on the quantum processing system 195. To implement a logical gate this may involve executing multiple layers of instructions over L timesteps. The instructions could be a fusion measurement pattern, single qubit measurements, or other physical quantum instructions that correspond to the fault tolerant gate being executed and depending on the nature of the quantum hardware.

After the logical gate has been executed, we have accumulated L layers of measurement information which are bundled together and passed to the modular decoder system 200 (e.g., to one or more of the decoder modules 315A-315N) for parallel execution.

In some embodiments, the modular decoder system 200 receives measurement information (e.g., the decoding problem, data to be decoded into logical data) and computes the corrected measurement result. In some embodiments, when decoding has finished, the outcome is passed back to the algorithmic control where it is used to compute which logical gate instructions are issued next (e.g., feedforward control).

Timescales: There are several timescales that are relevant to determining how the system is set up to ensure that logical gate instructions are available when they are needed:

Layer clock time—what is the time between each layer of the computation. We denote this by t_c. This timescale may vary significantly between different physical systems (e.g. in a photonic system, as fast as 1 ns to 1 μs).

Logical block time—the time to implement a logical gate over L layers, this can take time t_log=L*t_c. The value of L needed to reach target logical error rates of interest is typically in the range 30-50. We take a value of L=40 as an example. Depending on the level of interleaving applied t_log could be as low as 40 ns or larger than 40 μs.

Decoder latency (e.g., reaction time)—the time taken to run the decoder, t_D. Here we take this latency to be the time from the last measurement in the quantum system, to the time that the first logical instruction can be executed, e.g., it includes the time taken for signal transmission in/out of the quantum system, and the computation of algorithmic instructions. This timescale is indicated by the thick arrow in FIG. 5. The decoder runtime depends on the system size, the error rate, the decoding algorithm. The runtime also depends on the measurement configuration, and so in reality the time will be different for every run, following some distribution.

We can consider three different regimes of these timescales which will require different arrangements and methods of the decoding system.

Immediate decoding: t_D<t_c—in the simplest scenario the decoder evaluation is completed within one layer clock cycle. In this case the logical instructions for gate 2 are available in time for the gate to be performed immediately after gate 1 with no lag.

Fast decoding: t_c<t_D<t_log—in the second scenario the decoder is slower than one clock cycle but is completed faster than the time taken to execute a complete logical gate. In this case there must be a lag between the completion of logical gate 1 and logical gate 2. However, for this logical qubit only one decoder processor is needed, as it will have finished executing the decoding problem for logical gate 1 by the time it needs to start decoding for logical gate 2. In other words, the decoder throughput is large enough to keep up with the rate at which information is produced.

Slow decoding: t_c >t_log—finally we consider the case where the decoder run time is longer than the logical gate time. In this case there must be a lag between gates, but an additional issue arises with the throughput of the decoder. With one decoder processor the first decoding problem will still be running when the second arrives. This results in a ‘backlog problem’, where the latency is essentially increasing with every subsequent gate as the queue of waiting decoding problems increases. Fortunately, this throughput problem can be resolved using multiple decoder processors to increase the throughput to match the quantum system.

The ‘immediate decoding’ scenario can be impractical to implement with practical computational resources, is in most systems decoder latencies must be considered. In some example embodiments, in addition to modular based decoding, overall decoding delays may be implemented to additional address decoding timing scenarios.

Decoder system design to handle slow decoding: To address the issues that arise in the ‘fast decoding’ and ‘slow decoding’ regimes defined in the previous section we can use a combination of modifying the logical circuit to allow for decoding latency and adding additional processors to increase throughput.

Decoder Gate Delay: When the decoder latency is longer than the layer clock time then we can use decoder delaying to allow the target logical qubit to wait until the next logical gate instructions become available. This delay simply implements an identity region after each logical gate where the measurement outcome is needed for feedforward. This identity operation has no logical effect on the qubit.

In some embodiments, the delay could be chosen to be a fixed duration before each feedforward operation, of a time long enough to cover all decoding run times. Alternatively, the duration of the delay region could be chosen adaptively, such that the logical qubit waits in memory until the next gate instruction becomes available. As used in FIG. 5, the delay refers to delay of a portion of the program (e.g., one or more qubit lanes) to wait for results from other parts of the program; which is distinguishable and different from the buffer commit regions discussed below that are added to some partitioned edge region.

Decoder modularization (e.g., parallelization): If the logical latency is slower than the logical clock speed then in addition to the buffer, we can include additional modular decoding processors as discussed here to increase overall throughput.

As discussed above, the large decoding problem can yield latencies (e.g., increases in reaction time) that can lead to backlog errors which can slow down or altogether stop the quantum computation from running. Furthermore, simply separating a big task and the sub-tasks in the fault tolerant environment is difficult and nontrivial because in fault tolerant decoding of sub-tasks relies on neighboring sub-tasks data; that is, the decoding sub-problems must all communicate with each other to determine a global correction. Accordingly, not all sub-problems can be decoded in parallel, due to the dependencies among them in some embodiments. In some example embodiments, the modular decoder system 200 is configured to generate scheduling data (e.g., DAG) to specify an order in which the sub-decoding problems are processed by the decoder units.

In the following discussion, the region being decoded by a given subject decoder module is referred to as a commit region (e.g., edge commit data region, vertex commit data region). In some embodiments, the different decoder modules process different commit region data using data (e.g., correction data, neighboring syndrome data) from other commit regions. If the modular decoders to not have access to other neighbor regions data (e.g., syndrome data, correction data), then low weight errors may collect and give rise to larger logical failures across one or more of the module decoders. In some embodiments, a decoder module decodes the physical measurement data for the edge region and the buffer regions added to the edge-region. While the decoder module processes the edge region and buffer region data, in some embodiments the decoder module only reports only reports or makes available the processed edge region data to the other decoder modules. In some embodiments, a decoder coordinator and scheduling is configured to combine all of the decoded data from the sub-decoder units. In some embodiments, the modular decoder system 200 is configured to set the size of the buffers of a given edge commit data region to a set size based on code distance d (e.g., set to d, set to greater than (d−1)/2, determined via buffer growth).

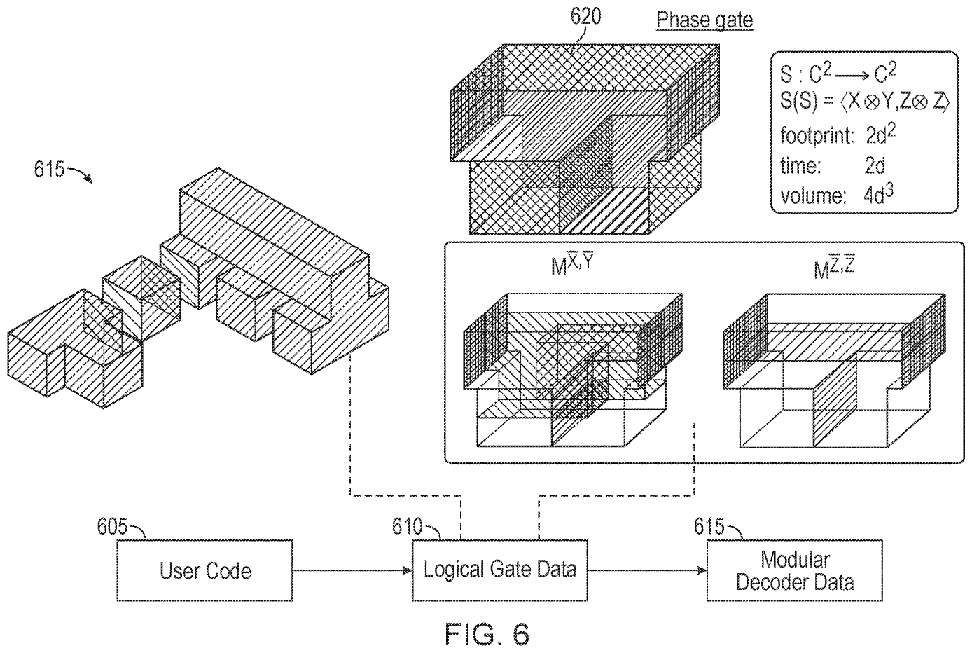

FIG. 6 shows a data flow architecture 600 for processing user instructions into logical block network data, in accordance with some embodiments. User code 605 comprises user input instructions such as quantum circuit data in Box A (FIG. 1I), logical blocks, ZX diagrams, high-level computer code (e.g., C++, Java, Python), specifying one or more operations to perform using the quantum processing system 195 (FIG. 2).

In some embodiments, the user code 605 is converted into logical gate data 620, such as logical block data or ZX diagrams that can be parsed by the quantum hardware. In some embodiments, the instruction system 203 comprises logic and stored correlations to translate each user specified instruction into blocks of a logical block network (e.g., identity block, Hadamard Block, GHX block, GHZ block as in FIG. 1I). In some example embodiments, users can generate logical block networks directly, by ordering and stacking different logical block units (e.g., GHX block on a identity block, and so on), and the convention of user code 605 into logical gate data 610 is skipped.

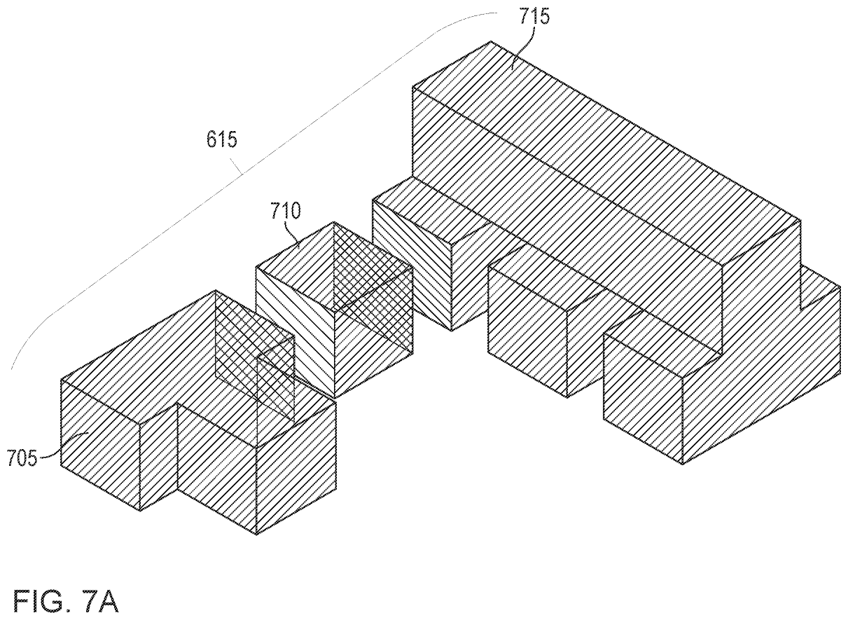

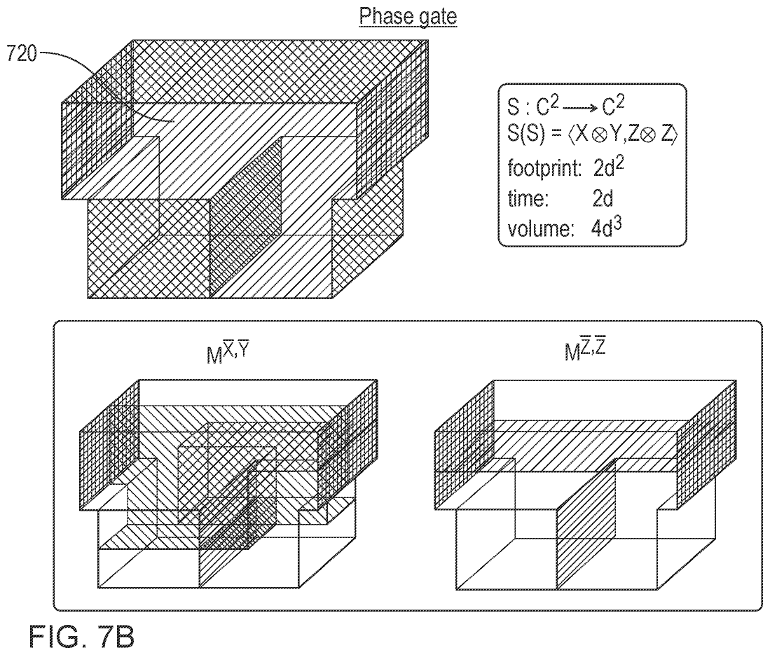

FIG. 7A shows further details of the example logical block network data, in accordance with some embodiments. As illustrated, the logical block network data 615 comprises a plurality of blocks including a first logical block 705 (e.g., for a first logical block operation), a second logical block 710 (e.g., for a second logical block operation), and a third logical block structure 715 comprising an combination of logical blocks for connection with the first logical block 705 and second logical block 710, which can create a logical qubit network block set of instructions for logical qubit based task processing. Processing of the logical block network data 615 can correspond to processing slices of the blocks, where each slice can include first commit data and second commit data.

FIG. 7B shows details of a phase gate logical block 720, as an example. The example phase gate logical block 720 corresponds to a phase gate instruction (e.g., to shift the phase of a given qubit by a specified amount) where the phase gate logical block 720 can be sliced from left to right to form the instructions for the quantum processor 501, as discussed above with reference to FIG. 5.

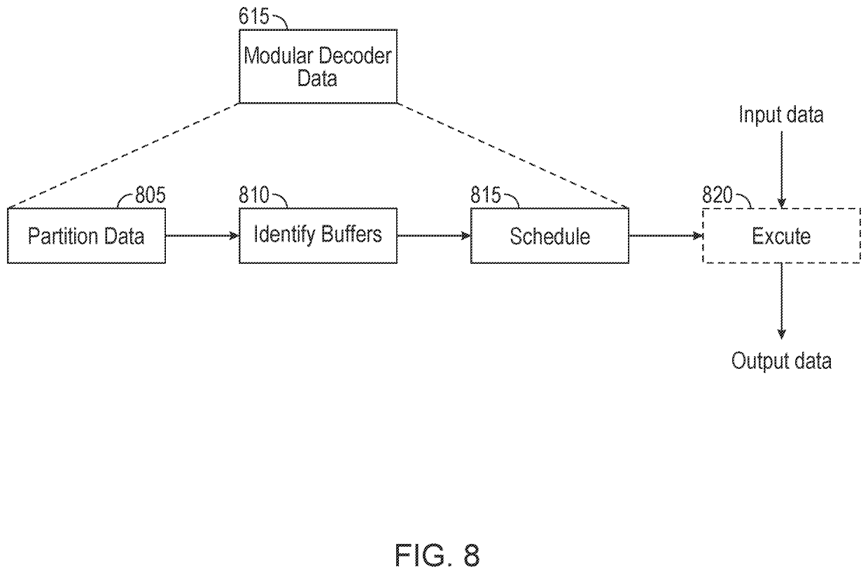

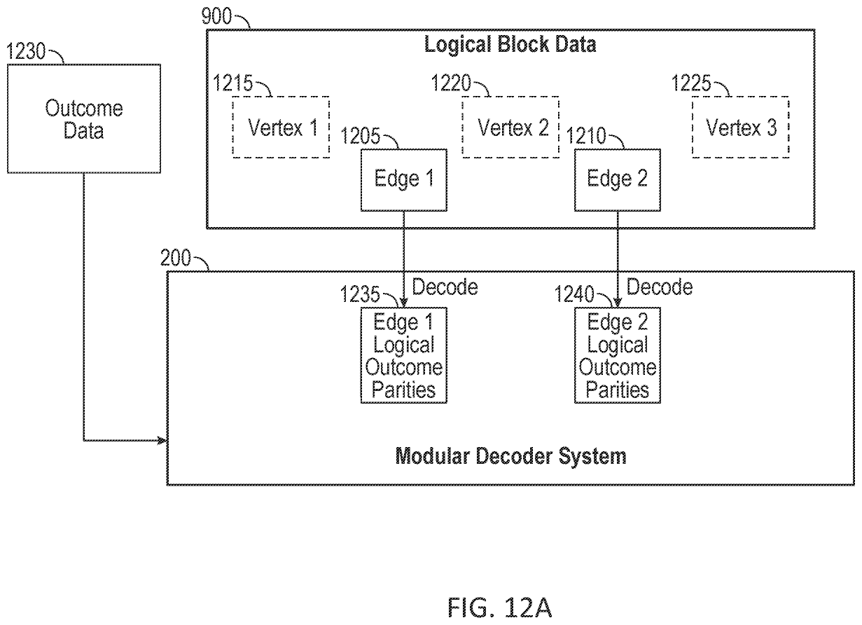

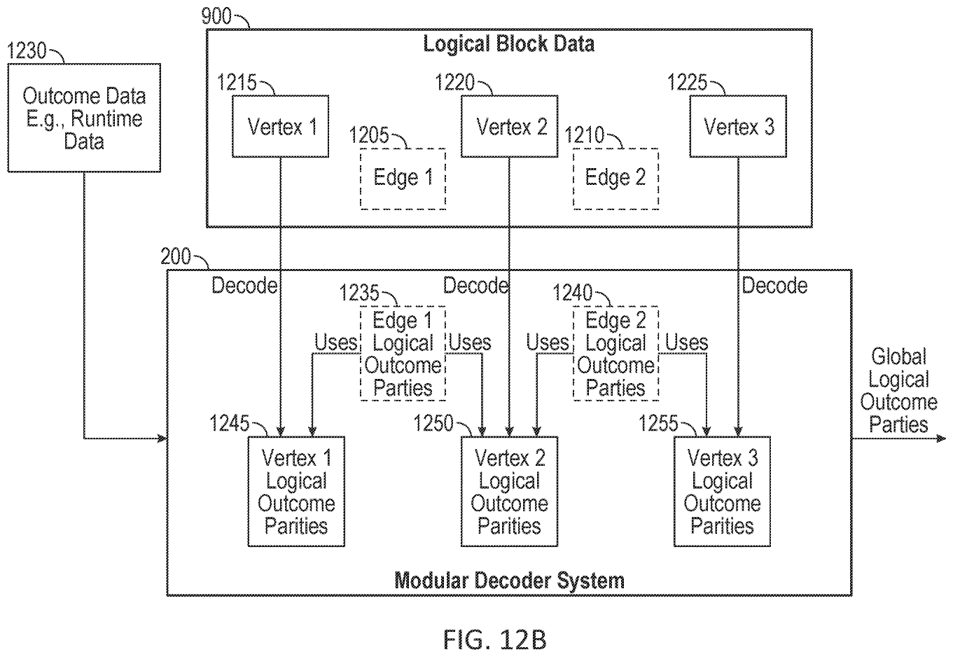

FIG. 8 shows a data flow architecture 800 for processing logical block network data using the modular decoder system 200, in accordance with some embodiments. In the example illustrated of FIG. 8, a plurality of sub-operations 805, 810, and 815 are illustrated to show a modular decoding approach for processing the logical block network data 615 using the modular decoder system 200, in accordance with some embodiments. At a high-level, at the end of operations 805, 810, and 815, the logical block network data comprises edge region data (e.g., thin sliced data, edges data), vertex commit region data (e.g., chunk data, vertex data), and specified buffer regions, which can then be used for runtime execution at operation 820, as further discussed below with reference to FIG. 12A in FIG. 12B.

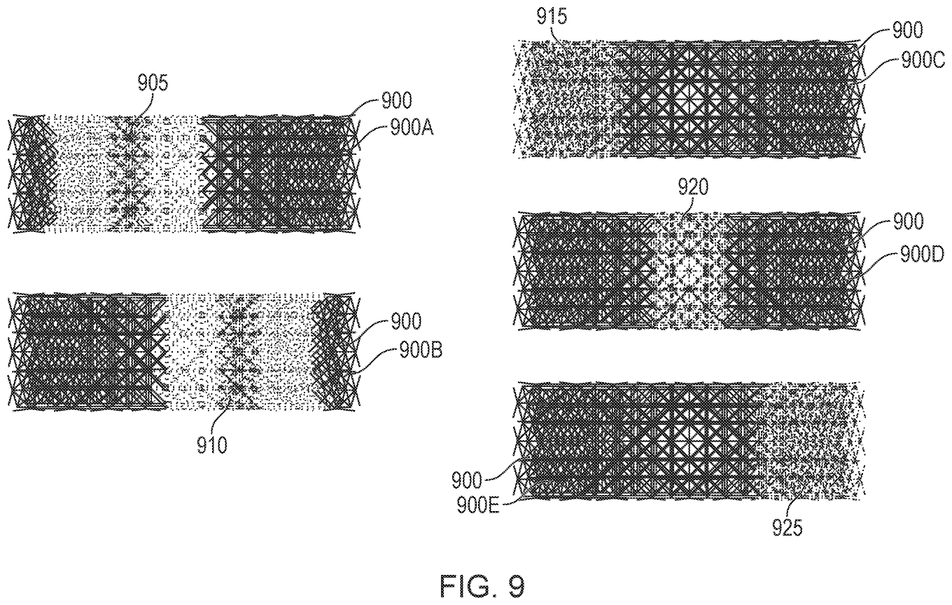

At operation 805, logical block network data is partitioned. FIG. 9 shows an example of partitioning logical block network data, in accordance with some embodiments. In FIG. 9, the example logical block network data 900A-900E correspond to the same logical block network data 900 (e.g., a slice of a block), which are shown separated in FIG. 9 (e.g., as logical block network data 900A, logical block network data 900B) to show the different edge commit and vertex commit and their alignments within the given dataset (e.g. slice).

As an example, at operation 805, edge region 905 and edge region 910 are identified in the logical block network data 900. As shown by the alignment in FIG. 9 of the logical block network data 900A and logical block network data 900B, the two example identified network regions are offset from one another and can be decoded simultaneously (e.g., in parallel, concurrently in a first edge commit-stage decoding phase) on two different decoder modules.

Further, at operation 805, vertex commit region 915, vertex commit region 920, and vertex commit region 925 are identified in the logical block network data 900. As shown in FIG. 9 in the logical block 900C, logical block 900D, and logical block 900E, the three vertex commit regions are offset from one another and can be decoded simultaneously (e.g., on three example decoder modules (e.g., three of the decoder modules 315A-315N).

Continuing with reference to FIG. 8, at operation 810, the modular decoder system 200 identifies buffer regions. In some example embodiments, the buffers can be of a threshold size configured in the modular decoder system 200 based on the code distance (e.g., fault distance). For example, setting the buffer size to the code distance, d, or setting the buffer size such that it is greater than d−1/2.

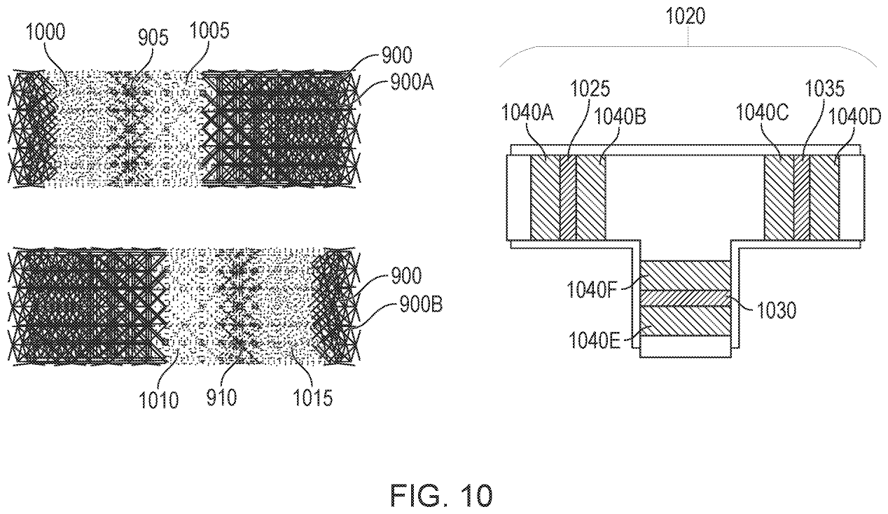

FIG. 10 shows an example of identification of buffer regions in different logical network block data sets, in accordance with some embodiments. For example, in the buffers schematic, buffers of the identified threshold size including buffer 1000 and buffer 1005 are configured to pad the edge region 905. Likewise, buffer region 1010 and buffer region 1015 of the same determined size are added to the edge region 910. FIG. 10 also shows a more complicated logical network block 1020 as an additional example. As shown, the logical network block 1020 comprises a first edge region 1025, a second edge region 1030, and third edge region 1035. In the example of the logical network block 1020, the same or a different buffer region size may be set and added to each of the edge regions including buffers 1040A-1040D.

Continuing with reference to FIG. 8, at operation 815, the modular decoder system 200 schedules the identified edge commit and vertex commit regions for execution (e.g., upon receipt of qubit measurement data, such as photonic qubit measurement data, ion qubit measurement data). In some embodiments, the modular decoder system 200 is configured to implement different scheduling schemes including: a vertex only scheduling scheme, a sequential vertex decoding scheme, a parallel vertex decoding scheme, and the edge and vertex decoding scheme, in accordance with some embodiments.

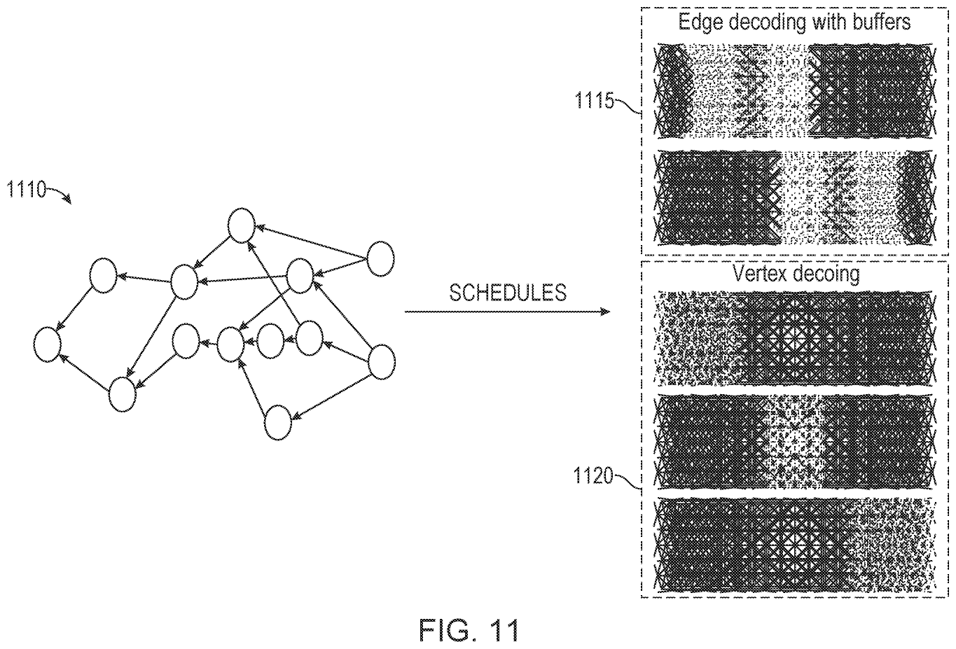

FIG. 11 shows an example scheduling graph 1110 (e.g., a directed acyclic graph) that is generated by the modular decoder system 200 to specify an order for decoding edge regions along with each edge region's buffer in an edge commit decoding phase 1115 in which each edge region is decoded in parallel by one of the decoder modules 315A-315N. The scheduling graph 1110 can further schedule a vertex commit region decoding phase 1120 in which each of the vertex commit regions are decoded in parallel using different decoder modules 315A-315N. Further, as discussed with reference to FIG. 4, in some embodiments, the scheduling graph 1110 to perform scheduling of different feed forward operations such as different qubit branches that depend on the outcome of another qubit branch in operation or run time of the quantum algorithm.

Continuing with reference to FIG. 8, upon completion of scheduling at operation 815, input outcome data (e.g., runtime measurement data from qubit measurements from the quantum processing system 195) can be executed using the generated modular decoder data generated from the previous operations 805 to 815.

FIGS. 12A and 12B show example processing for modular decoding in which the decoder units use data from other decoder units, in accordance with some embodiments. FIG. 12A shows example decoding in an edge region decoding phase (e.g., first commit region decoding), in accordance with some embodiments. In the example of FIGS. 12A and 12B, the edge region 1 1205 includes an edge region (e.g., edge region 905) and its corresponding buffer regions (e.g., buffer 1000, buffer 1005), and likewise edge region 2 1210 includes a second edge region (the edge region 910) and its corresponding buffer regions (e.g., buffer region 1010, and buffer region 1015). Whereas, for example, vertex commit regions 1215, 1220, and 1225 correspond to bulk commit regions without buffers, as discussed above (e.g., vertex commit regions 915, 920, and 925). Continuing, in FIG. 12A, outcome data 1230 is generated from the quantum hardware 313A-313N (e.g., photon detector arrays), which populate the parameter regions of the vertex and edge regions in the partitioned logical block values. In some embodiments, as discussed above, the outcome data associated with the edge regions are decoded in parallel using separate modular decoder units (e.g., two modular decoders of modular decoders 315A-315N) to generate outcome data 1235 and outcome data 1240. As discussed above, in decoding the portions of the outcome data 1230 that corresponds to a given edge region, the given edge regions buffer data values from the outcome data 1230 are also decoded and used as updates.

Next, in a subsequent vertex region decoding phase (e.g., bulk region decoding) shown in FIG. 12B, portions of the outcome data 1230 that correspond to each vertex commit regions 1215, 1220, and 1225 are decoded in parallel to generate corresponding vertex commit region outcomes parities data, 1245, 1250, and 1255. The decoding of the outcome values that correspond to vertex commit regions can depend on values from the neighboring region (e.g., the decoded thin region data) to successfully yield global outcome parities data, which can then be output for further processing (e.g., further syndrome updates in classical feed forward operations), in a periodic or “on-the-fly” manner (e.g., as layers of logical block network data 900 and/or outcome data 1230 are generated).

FIGS. 13A-13E show example data structures for modular decoder system 200 implementing magic-stage injection, in accordance with some embodiments. At a high level, FIGS. 13A-13C show a quantum circuit (e.g., FIG. 13A) that is decomposed into a logical block network 1300 (e.g., FIG. 13B), which is then decoded in an edge decoding stage (FIG. 13C, left), a vertex decoding stage (e.g., FIG. 13C, right). In some example embodiments, the quantum circuit can be omitted and the logical block network 1300 can be constructed directly using different units of blocks (e.g., identity block, GHX block, GHZ block, a phase block, and so on).

FIG. 13D and FIG. 13E show example scheduling using a graph data structure (e.g., directed acyclic graph), in accordance with some embodiments. FIG. 13D shows the logical block network 1300 that is decomposed into two logical blocks, including: a “tri” logical block 1306 and a “left-turn” logical network block 1309. In FIG. 13D, the edge regions are labeled with letters “A”, “B”, “C”, “D”, where the buffer regions that are shown in FIG. 13C (left) are omitted in FIG. 13D for brevity. In example of FIG. 13D, a first vertex region for the “tri” logical block 1306 is labeled as “1”, and a second vertex region for the “left-turn” logical network block 1309 is labeled as “2”, where the two vertex regions share the “B” edge region (e.g., neck, thin slice, interface, port).

In some embodiments, the modular decoder system 200 generates scheduling using a directed acyclic graph 1307 (DAG). In the directed acyclic graph 1307, the vertex commit regions and edge commit regions are both shown as nodes (e.g., circles, dots) that are connected by arrows. For clarity, the directed acyclic graph components (circles or dots, and arrows) are here referred to as nodes and arrows when discussing a DAG, but vertex and edges when referring to components of a logical block network 1305. The direction of the arrows that connect the nodes in the directed acyclic graph 1307 indicate the scheduling by the decoder modules (e.g., 315A-315N). In accordance with some embodiments, four different decoder modules first process the edges A, B, C, and D in an edge decoding phase 1310 (e.g., each edge commit region data is decoded with its buffer region data in parallel, or concurrently by different decoder modules). After the edge decoding phase 1310, two different decoder modules then process the vertex commit data in the vertex decoding phase 1315. In some embodiments, a given decoder module receives correction data committed, such as boundary condition data 1311.

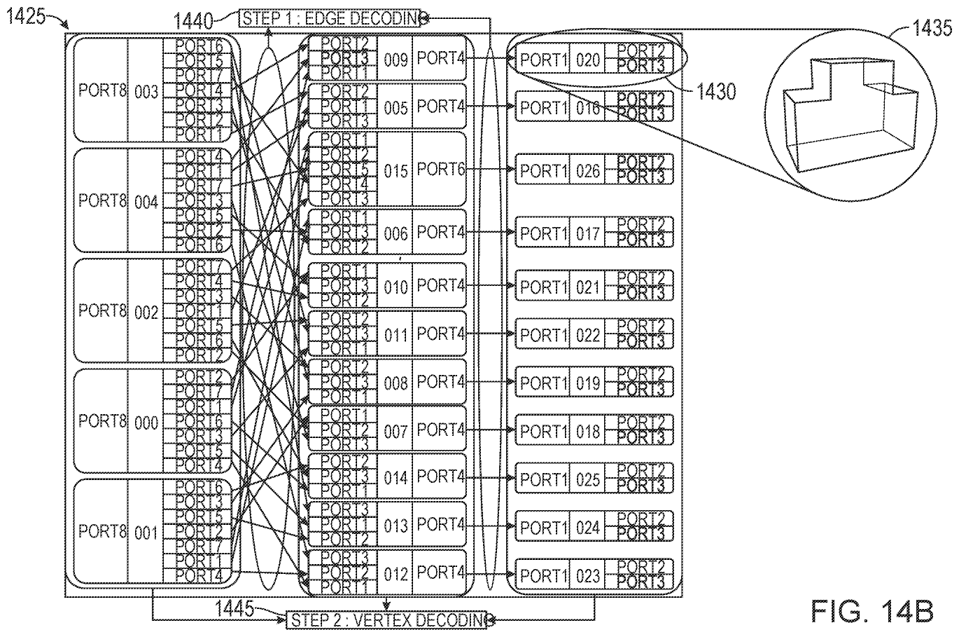

FIG. 14A shows an example data flow architecture 1400 (e.g., quantum circuit) for modular decoding is in the modular decoder system 200 to implement magic state distillation, in accordance with some embodiments. In FIG. 14A, an example blue box quantum circuit notation for a non-destructive Pauli measurement (e.g., Pauli product measurements or PPM) of P is displayed, in accordance with some embodiments. In the illustrated example, the blue box quantum circuit is a quantum circuit for a 15-to-1 magic state distillation quantum algorithm that using 11 auto-corrected T gates. In the illustrated example, the static Clifford part is marked with a dashed outline and grey background. The circuit can be reduced to GHZ type logical blocks, where modular decoding is performed in two steps, in accordance with some embodiments. In the first step, parallel edge decoding (e.g., parallel edge region decoding with each thin regions one or more buffers) for all 46 interfaces with their respective buffers is performed. In the second step, parallel vertex decoding (vertex commit region decoding) for all the 27 interiors of the GHZ style logical blocks is performed.

FIG. 14B shows a logical network block scheduling data 1425, in accordance with some embodiments. In the logical network block scheduling data 1425, each vertex is a shown as a rectangular block having in-ports and out-ports which correspond to the edge regions. For example, as shown in call-out 1435, vertex 1430 is a “tri” logical block network having three edges or ports regions. In FIG. 14B, the vertexes correspond to nodes and the edge regions (e.g., edge/buffer data) are indicated by lines connected the vertexes. In some embodiments, the edge/buffer regions of the logical network block scheduling data 1425 are first processed by a plurality of decoder modules in the edge decoding phase 1440. Further, the vertex regions are then processed by a plurality of decoder modules in a subsequent vertex decoding phase 1445, where some of the vertexes decoding tasks will use some correction data from the earlier edge/buffer decoding of edge decoding phase 1440.

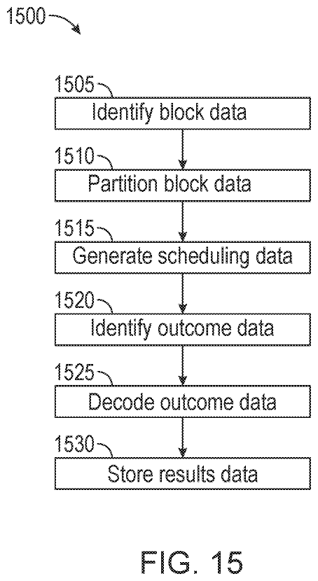

FIG. 15 shows a flow diagram of a method 1500 for implementing modular decoding using the modular decoder system 200, in accordance with some embodiments. At operation 1505, the modular decoder system 200 identifies block data. At operation 1510, the modular decoder system 200 partitions the block data. For example, at operation 1510, logical block data (e.g., syndrome data) is partitioned into edge regions and vertex commit regions, and buffers based on code distance are identified and added for processing to respective identified edge regions. At operation 1515, the modular decoder system 200 generates scheduling data (e.g., directed acyclic graph (DAG) data for processing the thin and vertex commit regions in different sequential stages). At operation 1520, the modular decoder system 200 identifies outcome data (e.g., measurement data from the quantum processing system 195). For example, with reference to FIG. 12A the modular decoder system 200 performs edge commit and buffer region processing, and, with reference to FIG. 12B, the modular decoder system 200 performs vertex commit region processing that uses results (e.g., corrections) from the edge commit and buffer decoding phase. At operation 1525, the modular decoder system 200 decodes the outcome data. For example, the decoding system performs decoding on first commit regions having buffers, second commit regions (that use boundary data), and generates a logical outcome data. At operation 1530, the modular decoder system 200 stores the results data. The stored data can be implemented to determine next tasks in the quantum instruction set (e.g., branch conditions, such as an S-gate in distillation), or other actions, such as redoing tasks or terminating computation in response to encountering logical errors.

Although in the above examples, edge tasks with buffers and vertex tasks are discussed with reference in a logical block approach, it is appreciated that the buffering approach can likewise be implemented without scheduling of edges and vertexes, where only one class has buffers. For example, buffers can be added to any commit region to generate updated boundary data that is communicated to a decoding handling a subsequent commit region. For instance, a set of data can have three commit regions, A, B, C, where each commit region has a buffer region that overlaps with a portion of the next commit region (e.g., A has a buffer that extends partially into B's commit data). Performing scalable modular decoding in this approach can include: (e.g., at operation 1525, FIG. 15) decoding A and A's buffer region, communicating the updated buffer region to B for use in generating it's correction; whereby in decoding B, B's buffer region is decoded to update its boundary data, which is communicated to the decoder handling C commit region, and so forth. In this way, decoding data can be modularized and decoded separately by different decoder units to lower reaction time and improve computing efficiency.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: identifying, on one or more processors, qubit measurement data; assigning portions of the qubit measurement data as first commit regions and buffer regions; assigning portions of the qubit measurement data as second commit regions that are bounded by the first commit regions, the first commit regions being adjacent to the second commit regions in the qubit measurement data, the second commit regions overlapping with one or more of the buffer regions; distributing, to a plurality of decoders, a first plurality of partitions of the qubit measurement data, a first partition of the plurality of first partitions comprising an first commit region and one or more of the buffer regions; generating, on the plurality of decoders, a first plurality of decoded datasets from the first plurality of partitions of the qubit measurement data, a decoder of the plurality of decoders generating a first decoded dataset of the first plurality of decoded datasets by applying a decoding scheme to a corresponding first partition of qubit measurement data that is received by the decoder, each decoded dataset of the first plurality of decoded datasets comprising decoded first commit region data and decoded buffer region data; distributing, to the plurality of decoders, a second plurality of partitions of the qubit measurement data, a second partition of the second plurality of partitions comprising a second commit region; generating, on the plurality of decoders, a second plurality of decoded datasets by applying the decoding scheme to the second plurality of partitions of the qubit measurement data; and generating, on the one or more processors, logical outcome data from the first plurality of decoded datasets and the second plurality of decoded datasets.

In Example 2, the subject matter of Example 1 includes, wherein the qubit measurement data comprises network graph data and the first commit region data comprises edge task data and the second commit regions comprise vertex task data of the network graph data, and wherein the edge task data and the vertex task data are processed according to a scheduling plan comprising a directed acyclic graph.

In Example 3, the subject matter of Examples 1-2 includes, wherein generating the logical outcome data comprises summing the first plurality of decoded datasets and the second plurality of decoded datasets.

In Example 4, the subject matter of Example 3 includes, summing.

In Example 5, the subject matter of Examples 1~4 includes, wherein the qubit measurement data comprises detection data generated from photon detectors.

In Example 6, the subject matter of Examples 1-5 includes, wherein the plurality of decoders comprises a first set of decoders that decode the first plurality of partitions of the qubit measurement data, and wherein the plurality of decoders further comprises a second set of decoders that decode the second plurality of partitions.

In Example 7, the subject matter of Example 6 includes, wherein the first set of decoders decode the first plurality of partitions of the qubit measurement data and the second set of decoders decode the second plurality of partitions of the qubit measurement data based on boundary data from the first set of decoders.

In Example 8, the subject matter of Examples 1-7 includes, wherein the first plurality of partitions of the qubit measurement data and the second plurality of partitions of the qubit measurement data are processed according to a scheduling plan, the scheduling plan comprising a directed graph.

In Example 9, the subject matter of Examples 1-8 includes, wherein generating the logical outcome data comprises generating the logical outcome data based only on commit data.

In Example 10, the subject matter of Example 9 includes, wherein the logical outcome data is generated by processing decoded buffer data.

In Example 11, the subject matter of Examples 1-10 includes, wherein the first commit regions is more accurately decoded based on the decoding scheme being applied to the first commit regions and buffer data.

In Example 12, the subject matter of Examples 1-11 includes, identifying a preconfigured code distance.

In Example 13, the subject matter of Example 12 includes, wherein the preconfigured code distance, d, is set based on an error rate value of measurement devices that generate the qubit measurement data.

In Example 14, the subject matter of Example 13 includes.

In Example 15, the subject matter of Examples 1-14 includes, wherein the decoding scheme comprises one or more of: a Union Find decoding scheme, a minimum weight perfect matching decoding scheme, a belief propagation based decoding scheme.

In Example 16, the subject matter of Examples 1-15 includes, wherein the plurality of decoders are implemented by a plurality of processors.

In Example 17, the subject matter of Example 16 includes, wherein the plurality of processors comprises one or more of: a plurality of central processing units (CPUs), a plurality of graphical unit processors (GPUs), a plurality of field programmable gate arrays (FPGAs).

Example 18 is a computer-readable medium storing a set of instructions, the set of instructions comprising one or more instructions that, when executed by one or more processors (e.g., hardware processors) of a device, cause the device to perform operations to implement of any of Examples 1-17.

Example 19 is a system comprising one or more processors (e.g., hardware processors); and a memory storing instructions that when executed by the one or more processors cause the system to perform operations to implement of any of Examples 1-17.

In the foregoing detailed description, the method and apparatus of the present inventive subject matter have been described with reference to specific exemplary embodiments thereof. It will, however, be evident that various modifications and changes may be made thereto without departing from the broader scope of the present inventive subject matter. The present specification and figures are accordingly to be regarded as illustrative rather than restrictive.

What is claimed is:

1. A method comprising:
identifying, on one or more processors, qubit measurement data;
assigning portions of the qubit measurement data as first commit regions and buffer regions;
assigning portions of the qubit measurement data as second commit regions that are bounded by the first commit regions, the first commit regions being adjacent to the second commit regions in the qubit measurement data, the second commit regions overlapping with one or more of the buffer regions;
distributing, to a plurality of decoders, a first plurality of partitions of the qubit measurement data, a first partition of the plurality of first partitions comprising an first commit region and one or more of the buffer regions;
generating, on the plurality of decoders, a first plurality of decoded datasets from the first plurality of partitions of the qubit measurement data, a decoder of the plurality of decoders generating a first decoded dataset of the first plurality of decoded datasets by applying a decoding scheme to a corresponding first partition of qubit measurement data that is received by the decoder, each decoded dataset of the first plurality of decoded datasets comprising decoded first commit region data and decoded buffer region data;
distributing, to the plurality of decoders, a second plurality of partitions of the qubit measurement data, a second partition of the second plurality of partitions comprising a second commit region;
generating, on the plurality of decoders, a second plurality of decoded datasets by applying the decoding scheme to the second plurality of partitions of the qubit measurement data; and
generating, on the one or more processors, logical outcome data from the first plurality of decoded datasets and the second plurality of decoded datasets.

2. The method of claim 1, wherein the qubit measurement data comprises network graph data and the first commit region data comprises edge task data and the second commit regions comprise vertex task data of the network graph data, and wherein the edge task data and the vertex task data are processed according to a scheduling plan comprising a directed acyclic graph.

3. The method of claim 1, wherein generating the logical outcome data comprises summing the first plurality of decoded datasets and the second plurality of decoded datasets.

4. The method of claim 3, wherein the summing comprises mod 2 summing.

5. The method of claim 1, wherein the qubit measurement data comprises detection data generated from photon detectors.

6. The method of claim 1, wherein the plurality of decoders comprises a first set of decoders that decode the first plurality of partitions of the qubit measurement data, and wherein the plurality of decoders further comprises a second set of decoders that decode the second plurality of partitions.

7. The method of claim 6, wherein the first set of decoders decode the first plurality of partitions of the qubit measurement data and the second set of decoders decode the second plurality of partitions of the qubit measurement data based on boundary data from the first set of decoders.

8. The method of claim 1, wherein the first plurality of partitions of the qubit measurement data and the second plurality of partitions of the qubit measurement data are processed according to a scheduling plan, the scheduling plan comprising a directed graph.

9. The method of claim 1, wherein generating the logical outcome data comprises generating the logical outcome data based only on commit data.

10. The method of claim 9, wherein the logical outcome data is generated by processing decoded buffer data.

11. The method of claim 1, wherein the first commit regions is more accurately decoded based on the decoding scheme being applied to the first commit regions and buffer data.

12. The method of claim 1, further comprising: identifying a preconfigured code distance.

13. The method of claim 12, wherein the preconfigured code distance, d, is set based on an error rate value of measurement devices that generate the qubit measurement data.

14. The method of claim 13, wherein the error rate value comprises (d−1)/2.

15. The method of claim 1, wherein the decoding scheme comprises one or more of: a Union Find decoding scheme, a minimum weight perfect matching decoding scheme, a belief propagation based decoding scheme.

16. The method of claim 1, wherein the plurality of decoders are implemented by a plurality of processors.

17. The method of claim 16, wherein the plurality of processors comprises one or more of: a plurality of central processing units (CPUs), a plurality of graphical unit processors (GPUs), a plurality of field programmable gate arrays (FPGAs).

18. A system comprising:
one or more processors; and
a memory storing instructions that when executed by the one or more processors cause the system to perform operations comprising:
identify qubit measurement data;
assign portions of the qubit measurement data as first commit regions and buffer regions;
assign portions of the qubit measurement data as second commit regions that are bounded by the first commit regions, the first commit regions being adjacent to the second commit regions in the qubit measurement data, the second commit regions overlapping with one or more of the buffer regions;
distribute, to a plurality of decoders, a first plurality of partitions of the qubit measurement data, a first partition of the plurality of first partitions comprising a first commit region and one or more of the buffer regions;
generate, on the plurality of decoders, a first plurality of decoded datasets from the first plurality of partitions of the qubit measurement data, a decoder of the plurality of decoders generating a first decoded dataset of the first plurality of decoded datasets by applying a decoding scheme to a corresponding first partition of qubit measurement data that is received by the decoder, each decoded dataset of the first plurality of decoded datasets comprising decoded first commit region data and decoded buffer region data;
distribute, to the plurality of decoders, a second plurality of partitions of the qubit measurement data, a second partition of the second plurality of partitions comprising a second commit region;
generate, on the plurality of decoders, a second plurality of decoded datasets by applying the decoding scheme to the second plurality of partitions of the qubit measurement data; and
generate logical outcome data from the first plurality of decoded datasets and the second plurality of decoded datasets.

19. The system of claim 18, wherein the qubit measurement data comprises network graph data and the first commit region data comprises edges and the second commit regions comprise vertexes of the network graph data, and wherein the edges and vertexes are processed according to a scheduling plan comprising a directed acyclic graph.

20. A tangible computer-readable medium storing a set of instructions, the set of instructions comprising one or more instructions that, when executed by one or more processors of a device, cause the device to:
identify qubit measurement data;
assign portions of the qubit measurement data as first commit regions and buffer regions;
assign portions of the qubit measurement data as second commit regions that are bounded by the first commit regions, the first commit regions being adjacent to the second commit regions in the qubit measurement data, the second commit regions overlapping with one or more of the buffer regions;
distribute, to a plurality of decoders, a first plurality of partitions of the qubit measurement data, a first partition of the plurality of first partitions comprising an first commit region and one or more of the buffer regions;
generate, on the plurality of decoders, a first plurality of decoded datasets from the first plurality of partitions of the qubit measurement data, a decoder of the plurality of decoders generating a first decoded dataset of the first plurality of decoded datasets by applying a decoding scheme to a corresponding first partition of qubit measurement data that is received by the decoder, each decoded dataset of the first plurality of decoded datasets comprising decoded first commit region data and decoded buffer region data;
distribute, to the plurality of decoders, a second plurality of partitions of the qubit measurement data, a second partition of the second plurality of partitions comprising a second commit region;
generate, on the plurality of decoders, a second plurality of decoded datasets by applying the decoding scheme to the second plurality of partitions of the qubit measurement data; and
generate logical outcome data from the first plurality of decoded datasets and the second plurality of decoded datasets.
